(19) United States
(12) Patent Application Publication
(10) Pub. No.: US 2015/0220625 A1
(43) Pub. Date: Aug. 6, 2015

(54) METHODS AND APPARATUS FOR CONVEYING SURVEILLANCE TARGETS USING BLOOM FILTERS

(71) Applicant: INTERDIGITAL PATENT HOLDINGS, INC., Wilmington, DE (US)

(72) Inventors: John Cartmell, North Massapequa, NY (US); Xavier De Foy, Kirkland (CA)

(21) Appl. No.: 14/603,868

(22) Filed: Jan. 23, 2015

Related U.S. Application Data
(60) Provisional application No. 61/935,021, filed on Feb. 3, 2014.

(51) Int. Cl. G06F 17/30; H04L 29/06; H04M 3/22

(52) U.S. Cl. CPC G06F 17/30699; H04M 3/2281; G06F 17/30091; H04L 63/30

(57) ABSTRACT

The disclosure pertains to methods and apparatus for conveying surveillance targets using Bloom filters or the like in order to obfuscate the identities of the actual users that are under surveillance.

### FIELD OF THE INVENTION

This application relates to methods and apparatus for lawful interception (LI) of electronic communications. More particularly, this application relates to methods and apparatus for conducting LI when communications are offloaded to small cells and the like and thus do not pass through the core network.

### BACKGROUND

Lawful Interception (LI) may comprise obtaining communications network data pursuant to lawful authority, for example, by intercepting data as it traverses one or more communications networks. The network data may be intercepted for purposes of analysis, evidence gathering, or in support of other law enforcement activities. LI may be initiated at the request of at least one interested law enforcement agency (LEA).

In a typical LI architecture, data that traverses a communications network passes through one or more devices resident in a core of the communications network, such that a law enforcement management function (LEMF) that is resident in the core network may direct one or more core network devices to intercept selective communications network data. LI architectures that rely on data passing through the core network may be incapable of intercepting traffic routed by a local gateway or offloaded to a small cell.

### SUMMARY

Methods and apparatus are disclosed for conveying user identities of surveillance targets for Lawful Intercept to a network node comprising; creating a Bloom filter populated with the user identities of users under surveillance; and transmitting to the network node data for populating the Bloom filter with the user identities of users under surveillance.

In accordance with another aspect, the invention pertains to methods and apparatus for performing Lawful Intercept at a local node attached to a core communication network comprising: storing at the local node a Bloom filter populated with user identities of users under surveillance; testing the user identity associated with a first User Equipment (UE) attached to the local node against the Bloom filter to determine if the user identity corresponds to a user under surveillance; commencing a data flow through the local node involving the first UE; and if the Bloom filter indicates that the user identity associated with the first UE corresponds to a user under surveillance and the communication session is designated for offload from the core network, offloading the communication session and transmitting a copy of data flow information pertaining to communication sessions involving the first UE to the core network.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIGS. 1C, 1D, and 1E are system diagrams of example radio access networks and example core networks that may be used within the communications system illustrated in FIG. 1A;

FIG. 2 is a diagram showing addition of an item to a counting Bloom filter data structure in accordance with an exemplary embodiment;

FIG. 3A is a diagram showing addition of several more items to the counting Bloom filter data structure of FIG. 2 in accordance with an exemplary embodiment;

FIG. 3B is a diagram showing removal of an item from a counting Bloom filter data structure of FIG. 2 in accordance with an exemplary embodiment;

FIG. 4 shows an exemplary network topology in accordance with an exemplary embodiment;

FIG. 5 is a message sequence chart illustrating population and dissemination of a counting Bloom filter by an Administrative Function in accordance with an exemplary embodiment;

FIG. 6 is a message sequence chart illustrating the use of a counting Bloom filter by a local node in accordance with an exemplary embodiment;

FIG. 7 shows a topology for remotely managing a counting Bloom filter located at a local node in accordance with an exemplary embodiment;

FIGS. 8 and 9 show a message sequence chart for remotely managing a counting Bloom filter located at a local node in accordance with an exemplary embodiment;

FIG. 10 is a message sequence chart for provisioning of a local node in accordance with an exemplary embodiment; and

FIG. 11 shows a topology for generating and operating a counting Bloom filter computed by an Administrative Function, a Policy Engine, and a Random Process in accordance with an exemplary embodiment.

### DETAILED DESCRIPTION

A detailed description of illustrative embodiments will now be described with reference to the various figures. Although this description provides a detailed example of possible implementations, it should be noted that the details are intended to be exemplary and in no way limit the scope of the application. In addition, the figures may illustrate message sequence charts, which are meant to be exemplary. Other embodiments may be used. The order of the messages may be varied where appropriate. Messages may be omitted if not needed and additional flows may be added.

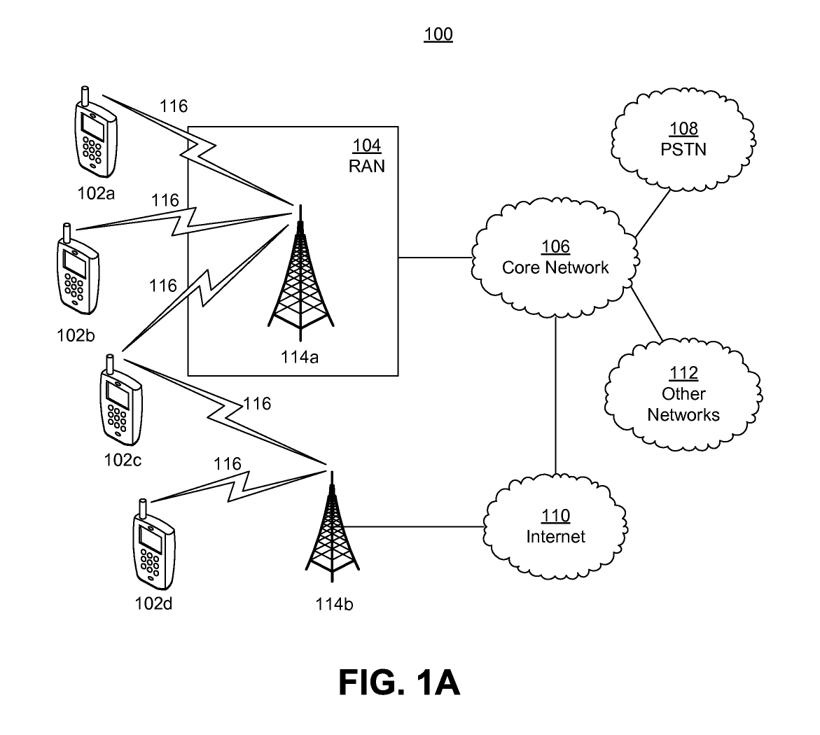

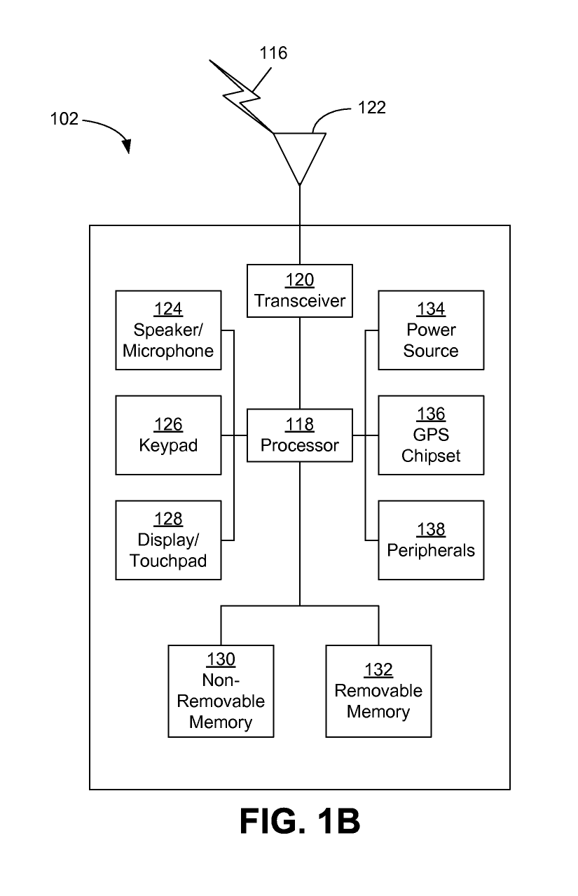

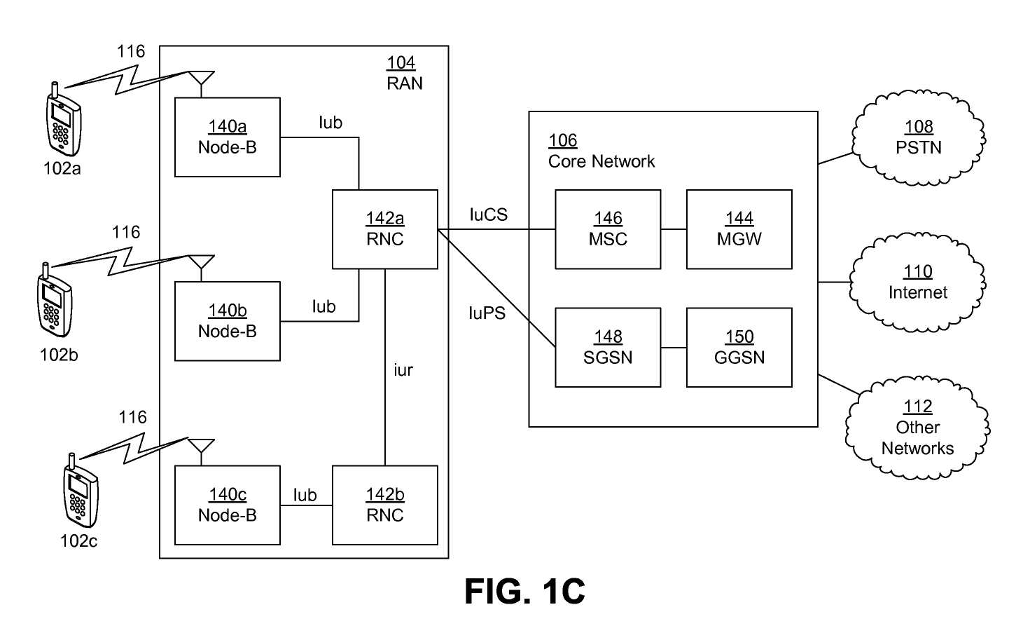

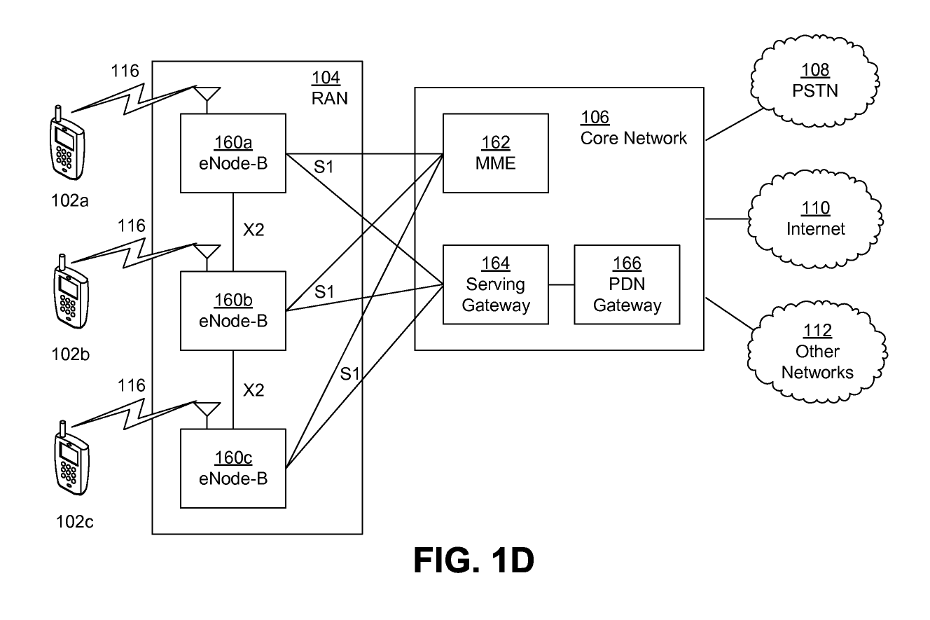

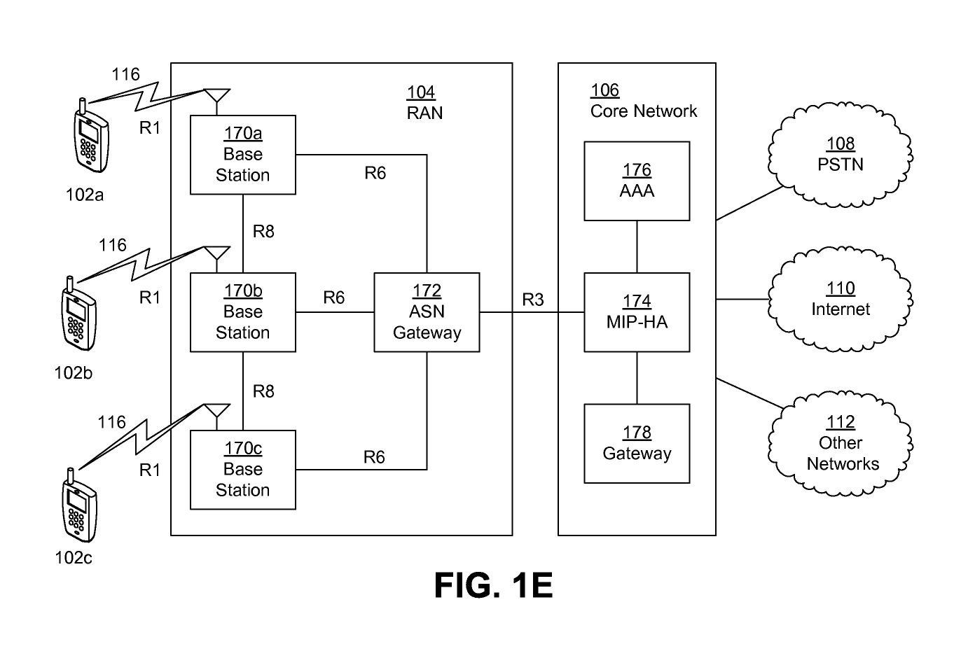

FIG. 1A is a diagram of an exemplary communications system 100 in connection with which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality, and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ a UTRA radio technology to communicate with the WTRUs 102a, 102b, 102c over the air interface 116. The RAN 104 may also be in communication with the core network 106. As shown in FIG. 1C, the RAN 104 may include Node-Bs 140a, 140b, 140c, which may each include one or more transceivers for communicating with the WTRUs 102a, 102b, 102c over the air interface 116. The Node-Bs 140a, 140b, 140c may each be associated with a particular cell (not shown) within the RAN 104. The RAN 104 may also include RNCs 142a, 142b. It will be appreciated that the RAN 104 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 104 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 104 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 1D is a system diagram of the RAN 104 and the core network 106 according to another embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink and/or downlink, and the like. As shown in FIG. 1D, the eNode-Bs 160a, 160b, 160c may communicate with one another over an X2 interface.

The core network 106 shown in FIG. 1D may include a mobility management gateway (MME) 162, a serving gateway 164, and a packet data network (PDN) gateway 166. While each of the foregoing elements are depicted as part of the core network 106, it will be appreciated that any one of these elements may be owned and/or operated by an entity other than the core network operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode Bs 160a, 160b, 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

FIG. 1E is a system diagram of the RAN 104 and the core network 106 according to another embodiment. The RAN 104 may be an access service network (ASN) that employs IEEE 802.16 radio technology to communicate with the WTRUs 102a, 102b, 102c over the air interface 116. As will be further discussed below, the communication links between the different functional entities of the WTRUs 102a, 102b, 102c, the RAN 104, and the core network 106 may be defined as reference points.

As shown in FIG. 1E, the RAN 104 may include base stations 170a, 170b, 170c, and an ASN gateway 172, though it will be appreciated that the RAN 104 may include any number of base stations and ASN gateways while remaining consistent with an embodiment. The base stations 170a, 170b, 170c may each be associated with a particular cell (not shown) in the RAN 104 and may each include one or more transceivers for communicating with the WTRUs 102a, 102b, 102c over the air interface 116. In one embodiment, the base stations 170a, 170b, 170c may implement MIMO technology. Thus, the base station 170a, for example, may use multiple antennas to transmit wireless signals to, and receive wireless signals from, the WTRU 102a. The base stations 170a, 170b, 170c may also provide mobility management functions, such as handoff triggering, tunnel establishment, radio resource management, traffic classification, quality of service (QoS) policy enforcement, and the like. The ASN gateway 172 may serve as a traffic aggregation point and may be responsible for paging, caching of subscriber profiles, routing to the core network 106, and the like.

The air interface 116 between the WTRUs 102a, 102b, 102c and the RAN 104 may be defined as an R1 reference point that implements the IEEE 802.16 specification. In addition, each of the WTRUs 102a, 102b, 102c may establish a logical interface (not shown) with the core network 106. The logical interface between the WTRUs 102a, 102b, 102c and the core network 106 may be defined as an R2 reference point, which may be used for authentication, authorization, IP host configuration management, and/or mobility management.

The communication link between each of the base stations 170a, 170b, 170c may be defined as an R8 reference point that includes protocols for facilitating WTRU handovers and the transfer of data between base stations. The communication link between the base stations 170a, 170b, 170c and the ASN gateway 172 may be defined as an R6 reference point. The R6 reference point may include protocols for facilitating mobility management based on mobility events associated with each of the WTRUs 102a, 102b, 100c.

As shown in FIG. 1E, the RAN 104 may be connected to the core network 106. The communication link between the RAN 104 and the core network 106 may defined as an R3 reference point that includes protocols for facilitating data transfer and mobility management capabilities, for example. The core network 106 may include a mobile IP home agent (MIP-HA) 174, an authentication, authorization, accounting (AAA) server 176, and a gateway 178. While each of the foregoing elements are depicted as part of the core network 106, it will be appreciated that any one of these elements may be owned and/or operated by an entity other than the core network operator.

The MIP-HA 174 may be responsible for IP address management, and may enable the WTRUs 102a, 102b, 102c to roam between different ASNs and/or different core networks. The MIP-HA 174 may provide the WTRUs 102a, 102b, 102c with access to packet-switched networks, such as the Internet 110, to facilitate communications between the WTRUs 102a, 102b, 102c and IP-enabled devices. The AAA server 176 may be responsible for user authentication and for supporting user services. The gateway 178 may facilitate interworking with other networks. For example, the gateway 178 may provide the WTRUs 102a, 102b, 102c with access to circuit-switched networks, such as the PSTN 108, to facilitate communications between the WTRUs 102a, 102b, 102c and traditional land-line communications devices. In addition, the gateway 178 may provide the WTRUs 102a, 102b, 102c with access to the networks 112, which may include other wired or wireless networks that are owned and/or operated by other service providers.

Although not shown in FIG. 1E, it will be appreciated that the RAN 104 may be connected to other ASNs and the core network 106 may be connected to other core networks. The communication link between the RAN 104 the other ASNs may be defined as an R4 reference point, which may include protocols for coordinating the mobility of the WTRUs 102a, 102b, 102c between the RAN 104 and the other ASNs. The communication link between the core network 106 and the other core networks may be defined as an R5 reference, which may include protocols for facilitating interworking between home core networks and visited core networks.

The above-referenced communications systems may be implemented, for example, as described herein, for performing a Selected IP Traffic Offload (SIPTO) function. For example, a Converged Gateway (CGW) may perform a Local SIPTO function. When an IP flow starts, the CGW may determine the type of IP flow. If the IP flow is of a certain type, for example, video or sent to or from a certain address range, the CGW may bypass the Evolved Packet Core (EPC) and/or route the data directly to an Application Server. The CGW may provide surveillance information associated with a device and/or a communication associated with a device.

The CGW may be configured for processing to perform the embodiments described herein. The CGW may provide a function that may be controlled by a policy. The policy, for example, based on traffic type, may route user's traffic in such a way so that the traffic bypasses a core network. The traffic type, for example, may be based on a user ID, a group of users, a 5-tuple of routing information (e.g., source IP address, destination IP address, source port number, destination port number, and application type, data type (video, voice over IP, FTP), etc. For example, an IP flow may be initiated in the uplink and/or the CGW may decide, based on user policy, for example, to perform SIPTO on the IP flow by routing it (e.g., directly) to the Application Server (e.g., instead of routing it through the EPC). In another example, an IP flow may be initiated in the downlink, e.g., through the EPC. The CGW may route uplink packets to the Application Server, e.g., via the EPC. The CGW may route the associated uplink packets via the EPC even if the policy for this IP flow for this user is to perform SIPTO.

One of the challenges associated with enabling Local Offload, Local IP Access, and SIPTO is Lawful Interception. For normal traffic that does not by bypass the core network (e.g., is not offloaded), the data between the UE and application server passes through the HeNB, CGW (Converged Gateway), SeGW (Security Gateway), SGW (Serving Gateway), and PGW (Packet Gateway). The SeGW, SGW, and PGW are in the core network and any of them may be equipped to perform LI. However, in the aforementioned cases of Local Offload, Local IP Access, and SIPTO as well as others, the data does not traverse the core network. Rather, using a common offload example, the data in the uplink is transmitted from the UE to the HeNB to a CGW and is routed directly to its destination (e.g., an application server), bypassing any node within the mobile core network. Likewise, downlink data is transmitted from the application server to the CGW to the HeNB to the UE, also bypassing the core network.

Hence, the conventional LI paradigm does not support this type of traffic. U.S. Published Patent Application No. 2013/0326631 discloses methods for extending the X1-1, X2, and X3 interfaces from equipment located inside the core network to equipment located outside the mobile core network, for instance, a Home e Node B (H(e)NB), Local Gateway (LGW) or converged Gateway (CGW). In that patent application, the IDs for the targets of surveillance are sent from the Admin Function in the core network to the local node where the local node would store them in some type of Trusted Environment (TrE) entity.

The passing and local storage of these IDs is potentially less than ideal. Particularly, neither the target of surveillance nor any other unauthorized person (such as a local administrator) should be able to access the list of users who are targets of surveillance. Passing the IDs to and/or storing the IDs on local nodes presents potential exposure of the IDs to such persons.

In order to better address this concern, rather than passing the actual IDs from the Admin Function to the local node, the Admin Function may instead pass a Bloom filter data structure to the local node as a means of conveying in an obfuscated manner which subscribers are targets of Lawful Interception and using the TrE within the local node to store the Bloom filter data structure. Then, when a flow is commenced, the IDs of the devices participating in the flow can be tested for whether or not they are members of the set described by the Bloom filter.

### 1 BLOOM FILTERS

A Bloom filter is a data structure that describes the members of a set [2] [3]. It can be a more compact representation than the set itself. Furthermore, determining membership in the set may be quicker using a Bloom filter data structure than traversing the entire set itself. However, for this convenience, there is a level of uncertainty with the test for membership of the set represented by the Bloom filter data structure.

There are several different types of Bloom filters, including a basic Bloom filter [4] and a counting Bloom filter [5]. A basic Bloom filter has a single bit for each entry in the data structure and is sometimes referred to as a simple Bloom filter. A counting Bloom filter has a multi-bit counter for each entry in the data structure. In the context of this document, the term “Bloom filter” is often used to indicate either a counting Bloom filter or a basic Bloom filter. It will be apparent from the context as to whether a counting, basic, or both are applicable in a specific instance in this specification.

There are three defined operations on a Bloom filter data structure, namely:
Addition of a member of the set;
Deletion of a member of the set; and
Test if an item is a member of the set.

In either a counting or basic Bloom filter, the Bloom filter data structure is initialized to zero for all entries. For a basic Bloom filter, once initialized, among the three operations mentioned above, addition and test can be performed in a relatively simple manner. However, deletion is supported by reconstruction of the Bloom filter (BF), as described in more detail below.

Adding a member of a set to the data structure of a basic Bloom filter requires the hashing of the member identity. Once hashed, the element in the data structure corresponding to the hashed value is set to 1. Testing if an item is a member of the set requires hashing that item's identity to derive a particular element in the data structure and determining if that element in the data structure is set to 1. If so, then the item is considered to be a member of the set. To delete a member of a basic Bloom filter, if the entity creating the Bloom filter retains the knowledge of what members were already added, when a member is removed, the entity can reconstruct the basic Bloom filter without that member.

For a counting Bloom filter, adding a member of a set to the data structure requires the hashing of the member identity. Once hashed, the corresponding element in the data structure is incremented by one. Deleting an item removed from the set requires the hashing of the member identity. Once hashed, the corresponding element in the data structure is decreased by one. Testing if an item is a member of the set requires hashing that item's identity and determining if the element corresponding to the hashed value in the data structure is greater than zero.

It is possible to use more than one hash function when creating a Bloom filter, for example, to add an item from a set. For instance, an item may be hashed using two different hashes to generate two different elements in the data structure, and then incrementing each of those elements in the data structure.

As should be apparent from the discussion above, a counting Bloom filter data structure has an element for each of the possible permutations and each element has a count which allows for deletion as well as addition of members without the need to reconstruct the data structure from scratch. The data structure could be quite large, but typically could be compressed significantly for transmission as, in all likelihood, the data structure will be sparsely populated and, hence, highly compressible for transmission.

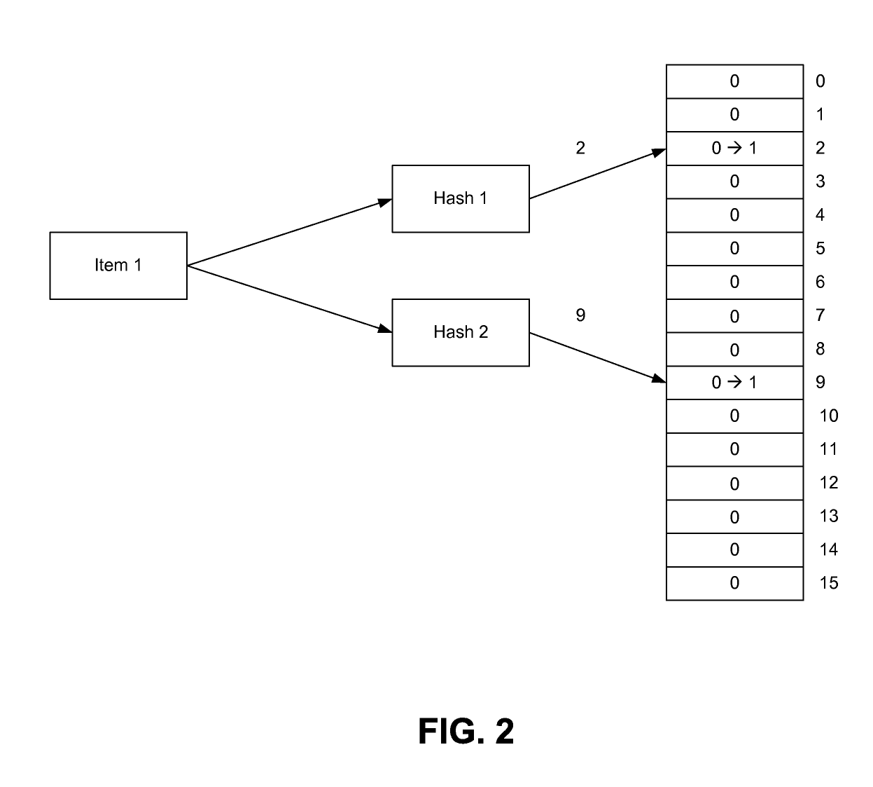

A simple example shown in FIG. 2 helps illustrate a counting Bloom filter and the operations that can be performed on it. Let us assume that we want to add an item to a data structure using two different hashes, each generating a 4 bit hash value. It should be understood that this example holds little practical value, but it explains the concept of adding a member to the data structure. In the first step, the identity of the item to be added is hashed using the two hash functions, thereby generating two values, e.g., 2 and 9. After this, the counter in each of these elements of the data structure is incremented by one as shown in FIG. 2. All the elements in the Bloom filter data structure are zero except for those at positions 2 and 9. The value of one in these elements indicates the number of members that hashed to that value (as will be discussed in more detail further below, it is possible for two different IDs to hash to the same value).

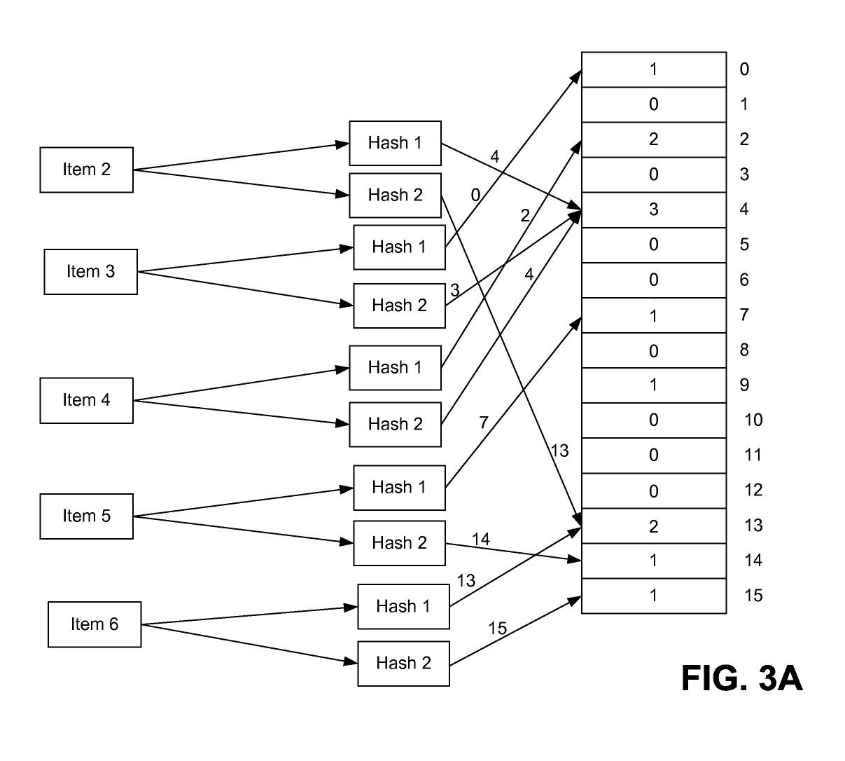

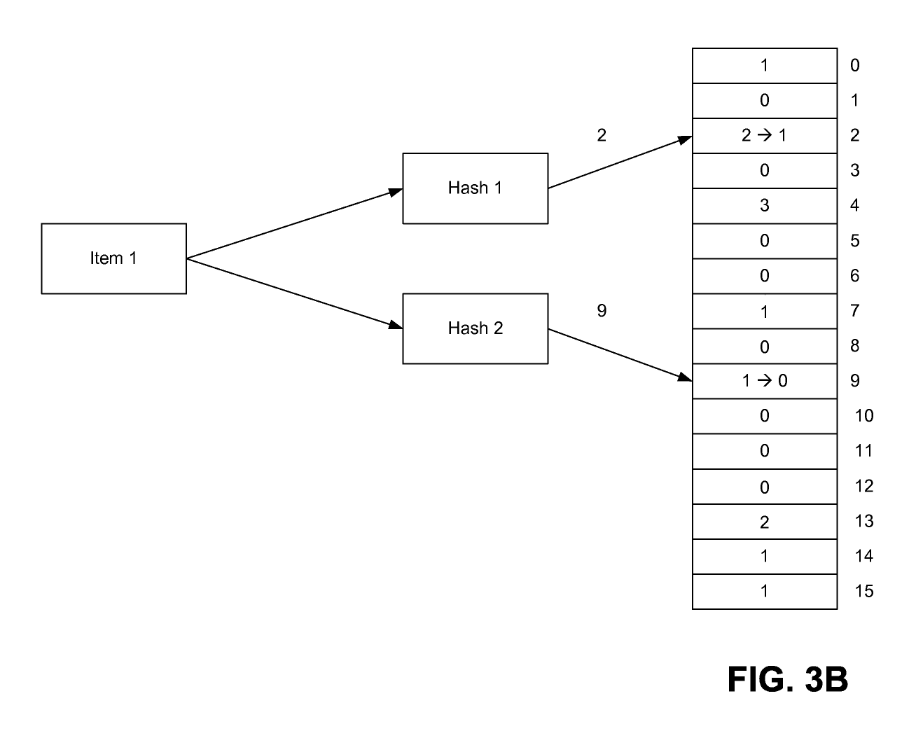

As a further example, let us assume that a number of other items are added into the counting Bloom filter data structure in the same manner, and then the item originally added is then removed from the set. As in the first addition case, each new item is hashed using each of the hash functions, generating two hash values for each new item. In this example, five additional IDs were hashed to ten additional hash values, resulting in the Bloom filter data structure shown in FIG. 3A. Note that one of the new items (i.e., item 4 using the first hash function) hashed to value 2 using one of the hash functions (as had item 1 previously), thus illustrating the aforementioned property that two different IDs could hash to the same value in a Bloom Filter. Also note that a few other IDs hashed to the same value in the Bloom Filter data structure (e.g., (a) item 2/hash function 1, item 3/hash function 2, and item 4/hash function 2 all hashed to hash value 4 and (b) item 2/hash function 2 and item 6, hash function 1 both hashed to value 13). Now, to delete the initial item, e.g., item 1, the count at each of the elements corresponding to its hash values is decremented by one. Recalling that item 1 hashed to values 2 and 9, items 2 and 9 in the Bloom filter data structure are each decremented by 1, as shown in FIG. 3B.

In order to test if an item is a member of a set, the item in question is hashed and the values in the data structure corresponding to the hash values are checked. If one or both are not greater than zero, then the item is definitely not a member of the set. If they are both greater than zero, then the item may be a member of the set. It can only be determined that the item is probably a member of the set, not absolutely. This is because two items may hash to the same value, and thus would increment the same element in the data structure. In order to compensate for this, if desired, additional hash functions can be used to reduce the false positive rate [6].

Hence, using a basic or counting Bloom filter, it is possible to determine with some degree of certainty (but less than 100%) that an item is a member of a set. Each “hit” can be either a false positive or a true positive. Furthermore, the degree of certainty is selectable (with limitations) as a function of the number of hash functions used as well as the particular hash functions used and the size of the Bloom filter. A false positive is when an item is incorrectly identified as a member of the set when it is not. A true positive is when an item is identified as a member of the set when it is. There are no false negatives with a simple Bloom filter. Hence, with a basic Bloom filter, it is possible to absolutely determine that an item is not a member of the set. This is a true negative. With a counting Bloom filter, it is also possible to absolutely determine that an item is not a member of the set, but only if designed to ensure that there are no counter overflows within the counting Bloom filter.

### 1.1 Use of Bloom Filter in Lawful Interception

As noted in the previous section, inherent to either counting or basic Bloom filter data structures is that false negatives do not occur (as long as no counter overflows occur for a counting Bloom filter), but false positives do occur. This characteristic can be used advantageously in connection with LI for traffic that is locally offloaded. A false negative in the LI scenario would constitute failure to identify a user who is the target of surveillance, which would generally be unacceptable. Accordingly, the fact that simple Bloom filters do not have false negatives and counting Bloom filters can be designed so that they do not have false negatives renders Bloom filters acceptable for use in LI.

On the other hand, a false positive in the LI scenario would constitute identifying a user as a target of surveillance when that user actually is not. Therefore, using a Bloom filter will yield more users being thought (by the local node) to be under surveillance than there really are. As discussed in more detail further below, this is not only acceptable, but can be used advantageously. Specifically, the existence of false positives can actually be used to obfuscate identifying the real targets of surveillance by unauthorized persons who might gain access to such information in the TrE of the local node. The amount of false positives can be controlled by the number of hash functions used to populate the Bloom filter as well as the number of bits used for the Bloom filter data structure. Unlike in conventional deployments of Bloom filters, a higher number of false positives may be desirable. So using fewer hash functions has a two-fold benefit. Specifically, (1) it puts less computation load on both the Admin Function and local node and (2) it increases the amount of obfuscation.

If a user was able to hack into the local node (already an unlikely scenario) and detect that the hash value corresponding to his/her identity matched the Bloom filter data structure, the user could not be certain he or she was an actual target of surveillance. Also, if a user was able to determine that his/her traffic was no longer being offloaded or that a copy of that user's data was being passed into the core network, the user also could not be certain he or she was actually a target of surveillance because such user could be a false positive, i.e., a user who has been marked as a target of surveillance but who is not.

It should be noted that the user ID used to identify a target of surveillance or even to identify a user is not specified herein. The present invention would work with IMSI, IMEI, S-TMSI, IP addresses, or any other specific UE identifier. As such, the actual user ID is irrelevant to this solution as long as the local node and the Admin Function have agreed a priori to the type of user ID employed.

To best protect the computation of the Bloom filter, the hash functions, and the seeds for the hash functions, these may be stored in the TrE of the local node. For a femtocell, this TrE is required by, and described in, the 3GPP standards [7].

Described below are specific embodiments using an exemplary counting Bloom filter. However, it should be understood that this is merely exemplary and that the same is also applicable to a basic Bloom filter.

### 1.2 Topology

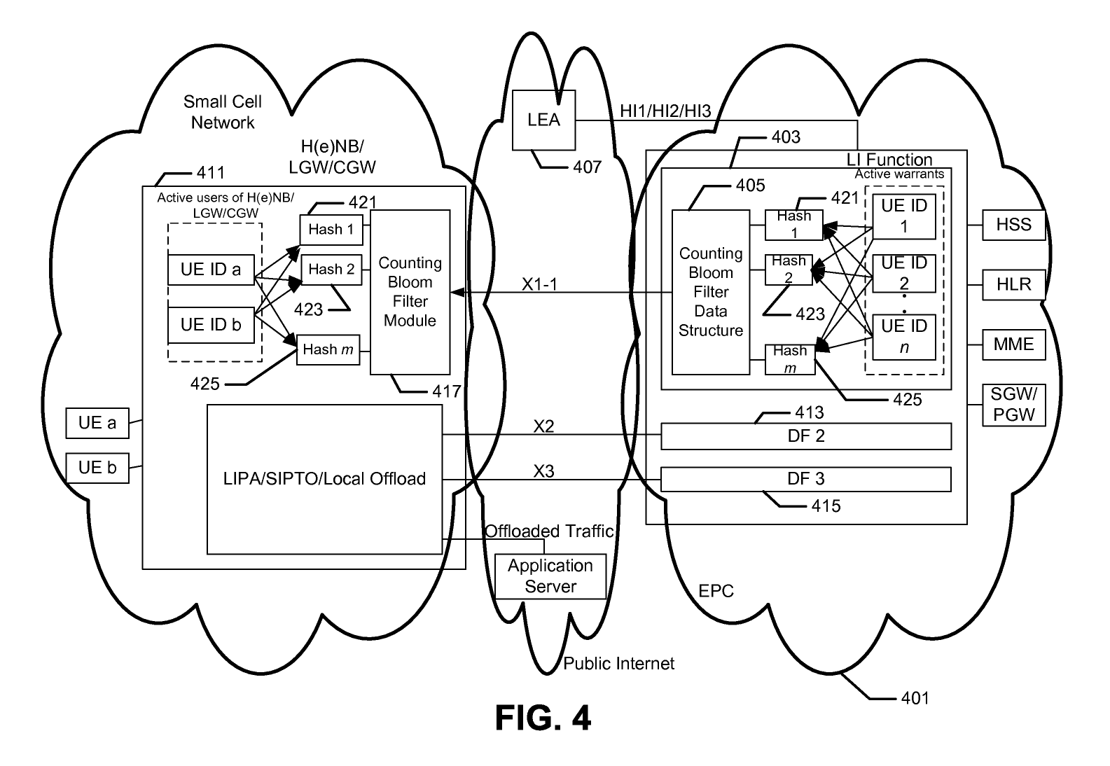

An exemplary network topology is shown in FIG. 4. Notice that the Administrative Function (Admin Function) 403 within the core network 401 is proposed to have a counting Bloom filter data structure 405 within it. The Bloom filter may be stored in any suitable memory device. The Admin Function 403 is proposed to have all that is needed to compute a counting Bloom filter data structure from user IDs, perform addition of a user, and perform deletion of a user. It is assumed that the Admin Function 403 is secure within the core network 401. The Admin Function 403 will still interface to the Law Enforcement Agency 407 using HI 1 as is currently described in the 3GPP standards and receive commands to activate or deactivate warrants for particular users. No change is necessary to this interface as defined in the 3GPP standards nor are any changes required to the HI 2 and HI 3 interfaces as defined by 3GPP. While not explicitly shown in this figure, the Data Forwarding (DF) 2 and DF 3 functions 413 and 415, respectively, are proposed to be augmented with the capability to determine when data is to be forwarded to a Law Enforcement Agency (LEA). Hence, this new logic can be configured so that it does not send the data that was received from the local node 411 over the X2 and X3 interfaces to the LEA 407 if it determines that the user was a false positive when it tests that user's actual unhashed identity against the original list of identities of the users who are under surveillance.

As was disclosed in aforementioned U.S. Patent Application 2013/0326631, which is incorporated fully herein, the X1-1, X2, and X3 interfaces may be extended from the Admin Function 403, DF 2 413, and DF 3 415 entities in the core network 401, respectively, to the local entity 411, that local entity being a H(e)NB, LGW or CGW. However, there is additional signaling over the X1-1 interface, that additional signaling being for the delivery of the counting Bloom filter data structure (which may be computed in the core network 401) from the core network 401 to the local node 411. Also disclosed in U.S. Patent Application 2013/0326631 was the use of a secure tunnel from the core network to the local node to carry the X1-1, X2, and X3 interfaces between the core network and a local node. That concept may be used herein for delivering the counting Bloom filter data structure to the local node.

The local node 411 may have a Bloom filter module 417 within it. This Bloom filter module will accept the counting Bloom filter computed by the Admin Function 403 in the core network 401 and save it in any appropriate memory device and will have the ability to test the ID of users connected to the local node 411 to determine if there is a match to the received counting Bloom filter. This Bloom filter module 417 should reside in the TrE area of the local node to resist tampering.

Each of the Admin Function, DF 2, DF 3, and local node Bloom filter module 417 may be implemented in any reasonable manner, including hardware, software, appropriate programming of a general purpose processor, logic circuitry, a dedicated digital or computer processing device, and/or any combinations of the above. Each also may be implemented as a portion of a larger purpose processing device or software application.

### 1.3 Functionality

Both the Admin Function 403 in the core network 401 and the local node 411 have Bloom filter functionality. In addition, the DF 2 413 and DF 3 415 in the core network 401 also have additional logic. This section describes the functionality in each element.

1.3.1 Admin Function

The Admin Function 403 is responsible for interfacing to the LEA 407 using the existing HI 1 interface. It will receive commands from the LEA 407 to either start or stop surveillance of particular users. In addition, the Admin Function will interface with the local node 411 as described in aforementioned U.S. Published Patent Application 2013/0326631. However, there are several new functions and a new message to the local node 411 that the Admin Function 403 may support. These are to enable the computation of the counting Bloom filter in the Admin Function 403 and the sharing of the counting Bloom filter with the local node 411.

The Admin Function 403 may have several hash functions 421, 423, 425 to support the creation and maintenance of the Bloom filter 405. Example hash functions include, but are not limited to, the Fowler-Noll-Vo hash [8] and the Murmur hash [9].

The Admin Function will be able to translate the IDs received from law enforcement into an ID used within the cellular network. It is assumed that the Admin Function will have access to the other nodes within the core network to determine this mapping.

The Admin function 401 will maintain a counting Bloom filter data structure 405, initializing it to all zeroes upon start-up, and updating it using the ability to translate the LEA-based ID to a cellular ID and the hash functions 421, 423, 425. It will update the Bloom filter whenever an LEA 407 informs it of the addition or removal of a user under surveillance (UUS). When an LEA starts surveillance of a user, it will send a message to the Admin Function informing the Admin Function of the new UUS, and the Admin Function will add this user into the counting Bloom filter data structure 405. When adding the user into the counting Bloom filter data structure, the Admin Function should ensure that an overflow does not occur to the counter(s) being incremented. When an LEA stops surveillance of a user, it will send a message to the Admin Function informing the Admin Function of the removal of the UUS, and the Admin Function will delete this user from the counting Bloom filter data structure 405.

It is possible that the Admin Function may occasionally have to test whether a user ID is a member of the counting Bloom filter data structure. For example, an LEA could query an Admin Function as to whether or not surveillance is enabled for a particular user. In this case, the Admin Function would test whether a user ID is a member of the counting Bloom filter data structure.

Whenever the counting Bloom filter data structure is modified, including its initialization at start up, the Admin Function will forward it to the local node 411 using the X1-1 interface between the Admin Function and the local node so that the local node can update its copy of the counting Bloom filter accordingly.

1.3.2 Local Node Function

The local node 411 will be responsible for testing user IDs of those users connected through the local node against the local copy 417 of the counting Bloom filter data structure (as received and/or updated from the Admin Function 403). To support this function, the local node 411 may support several features. All of the processing required with these counting Bloom filters should be performed in the TrE region of the local node to best prevent tampering and eavesdropping.

First, the local node 411 should support the receipt of the counting Bloom filter data structure from the Admin Function 403. Due to the dynamic nature of Lawful Interception, the local node should be able to accept an updated counting Bloom filter from the Admin Function at any time. Upon receipt of a new counting Bloom filter data structure, it should immediately replace the old counting Bloom filter with the new counting Bloom filter.

Next, the local node will have several hash functions, 421, 423, 425 to support testing against the locally stored counting Bloom filter data structure 417 received from the Admin Function. These hash functions 421, 423, 425 and any seeds for these hash functions must be identical to the hash functions 421, 423, 425 used within the Admin Function 403.

Third, the local node should be able to translate the IDs of the users attached through the local node into the same IDs used in the Admin Function to create the counting Bloom filter data structure. The local node may have access to the other nodes within the core network in order to have access to any data needed to determine this mapping.

Finally, the local node should be able to test each user connected to the network through the local node against the counting Bloom filter data structure received from the Admin Function. It will do this by using the hash functions 421, 423, 425 with the specific user ID as input to these hash functions. Once the hash functions have been executed, the results can be compared against the local copy of the counting Bloom filter data structure 417. If there is a match, it means that the user ID is a member of the set described by the counting Bloom filter data structure, and the local node should forward intercept-related information and content of communications to the DF 2 413 and DF 3 415 using the X2 and X3 interfaces for existing IP Flows. For new IP Flows of this user, the local node could allow offload and use the X2 and X3 interfaces to satisfy LI requirements, as is done for existing IP Flows. Alternatively, it may not allow the traffic offload (LIPA, ELIPA, or SIPTO) of new IP Flows for a matching user.

If there is no match, then the local node will do nothing to new or existing IP Flows for this user.

The local node may perform the above described logic upon the occurrence of specific events, such as:

A new user connects to the network through the local node;

An existing user starts a new IP Flow; and

A new counting Bloom filter data structure is received from the Admin Function.

1.3.3 X1-1 Interface

The size of the counting Bloom filter data structure could be quite large; especially a counting Bloom filter that supports both addition and deletion of user IDs. If a large hash size is used, the size of the counting Bloom filter data structure could be large. This could be costly to transfer over the X1-1 interface to each local node.

Therefore, it may be desirable for the Admin Function 403 in the core network 401 to compress the counting Bloom filter before sending it to the local node 411. If so, then the local node would have to decompress the counting Bloom filter before use. Any compression algorithm could be used. However, since the counting Bloom filter will most likely be sparse (assuming a small number of active surveillance targets), an algorithm that has a high compression ratio for sparse matrices could be used.

1.3.4 DF 2 and DF 3

Typically, the DF 2 and DF 3 functions 413, 415 within the core network receive intercept-related information or content of communications from a network element. As part of aforementioned U.S. Published Patent Application 213/0326631, the DF 2 and DF 3 could receive this information from a local node. Upon receipt of Intercept Related Information (IRI) and Content of Communications (CC) from a network element (or a local node), the DF 2 413 and DF 3 415 could pass this data to the appropriate LEA 407 using the HI 2 and HI 3 interfaces.

Since there is the possibility for a false positive, an additional step may be incorporated into this solution. Specifically, the DF 2 and DF 3 entities 413, 415 may first check that each data flow received from the local node 411 for LI is for an actual target of surveillance (a true positive) instead of a user who's user ID matched the counting Bloom filter data structure but who is not under surveillance (i.e., a false positive). If the data is for a “real” target of surveillance, then the DF 2 and DF 3 functions 413 and 415 can forward the data to the appropriate LEA 407 using the HI 2 and HI 3 interfaces as defined in the 3GPP standards. If, on the other hand, the data is not from a “real” target of surveillance, then the DF 2 and DF 3 functions 413 and 415 will not forward this data to the LEA (by, perhaps, dropping this data).

### 1.4 Message Sequence Charts

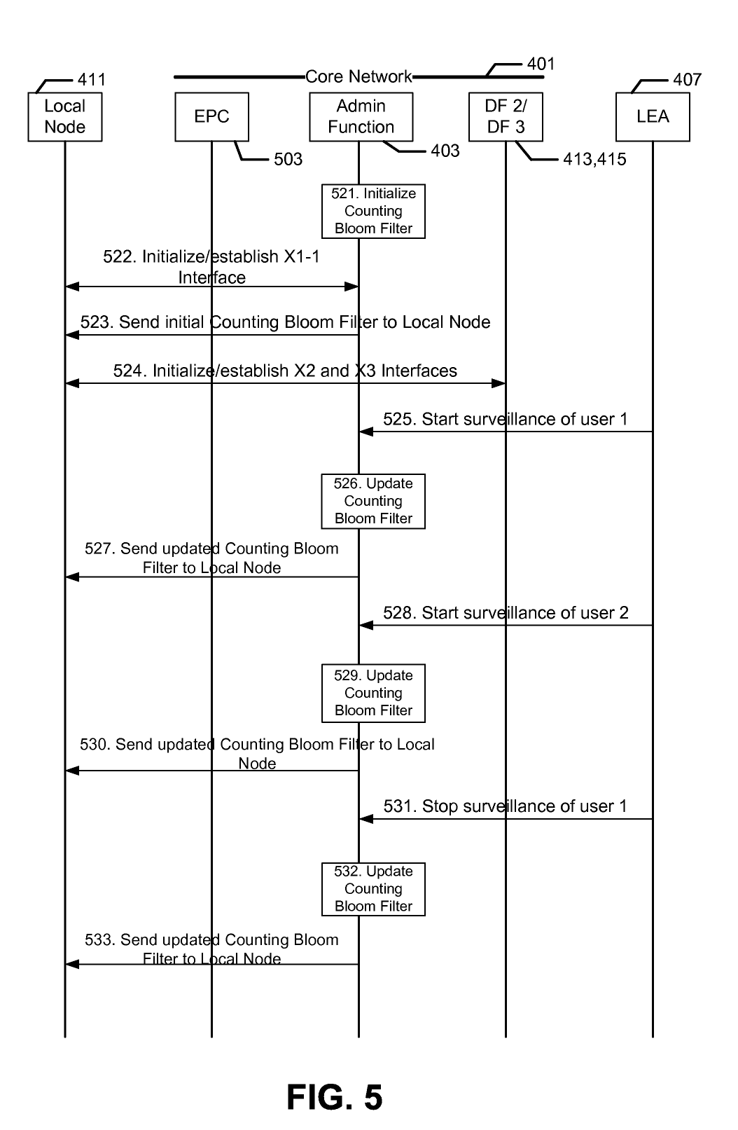

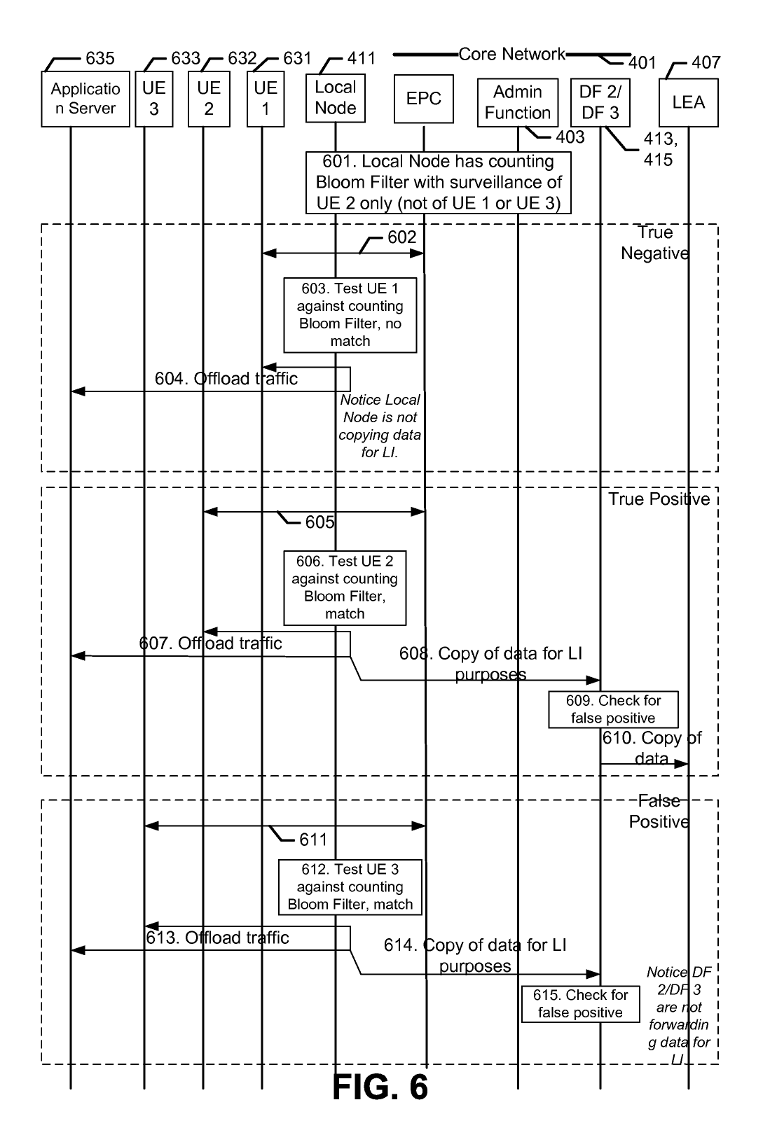

The following Message Sequence Charts (MSCs) show exemplary interaction between the Admin Function 403 in the core network 401 and the local node 411. In the first MSC, shown in FIG. 5, the interaction between the Admin Function 403, the LEA 407, and the local node 411 is highlighted for the case where surveillance is started or ended for specific users and the computed counting Bloom filter data structure is sent to the local node. In the second MSC, FIG. 6, the functionality of the local node 411 and its interactions with the DF 2 and DF 3 functions 413 and 415 are highlighted for a new IP Flow.

All three possible outcomes of testing a user ID against the counting Bloom filter data structure 417 are demonstrated in FIG. 6, those three possible outcomes being:
True positive—The user is the target of surveillance and matched by the counting Bloom filter data structure;
True negative—The user is not the target of surveillance and was not matched by the counting Bloom filter data structure; and
False positive—The user is not the target of surveillance but was, nonetheless, matched by the counting Bloom filter data structure.

A false negative case is not shown since it is not possible with a counting Bloom filter if overflow of the counters is prevented.

Starting from FIG. 5, at 521, the counting Bloom filter is initialized by the Admin Function 403. The initial counting Bloom filter will contain all zeroes.

At 522, the Admin Function 403 and the local node 411 establish the X1-1 interface through a secure tunnel between the local node 411 and the core network 401. It is assumed that the secure tunnel between the local node and the EPC 503 is already in place. At least one way to establish the tunnel is found in U.S. patent application Ser. No. 14/055,686, which is incorporated herein in its entirety by reference.

At 523, the Admin Function 403 sends the initial counting Bloom filter to the local node 411 using new signals over the X1-1 interface via the secure tunnel.

At 524, the local node and the DF 2 and DF 3 functions establish the X2 and X3 interfaces using the secure tunnel.

At some point after this initialization, at 525, an LEA 407 sends a command to the Admin Function 403 to start surveillance of user 1. This is done using the existing HI 1 interface and is covered by existing 3GPP standards.

At 526, the Admin Function 403 updates its copy of the counting Bloom filter 405 using the ID of user 1. The form of this ID, as mentioned previously, is not material. It updates the counting Bloom filter by using the ID of user 1 as input into one or more hash functions. The results of the hash functions will be added into the counting Bloom filter.

At 527, the Admin Function 403 sends this updated counting Bloom filter to the local node 411 using new signals over the X1-1 interface (same as step 523).

At some point thereafter, at 528, the LEA 407 sends a command to the Admin Function 403 to start surveillance of user 2. This is done using the existing HI 1 interface and is covered by existing 3GPP standards.

At 529, the Admin Function updates the counting Bloom filter using the ID of user 2. It performs this update by using the same process as in step 526. The outputs of the hash functions will be mapped into the counting Bloom filter.

In step 530, the Admin Function 403 pushes this updated counting Bloom filter to the local node 411 using new signals over the X1-1 interface (as in steps 523 and 527).

At some point in the future, at 531, the LEA 407 sends a command to the Admin Function 411 to stop surveillance of user 1. This command uses the existing HI 1 interface with existing signals as defined in the 3GPP standards.

At 532, the Admin Function 411 computes the hash value for the ID of user 1. Once computed, the results of the hash functions will be deleted from the counting Bloom filter.

At 533, the Admin Function 403 sends the updated counting Bloom filter to the local node 411 (similarly as in steps 523, 527, and 530).

At this point, the local node 411 has a counting Bloom filter designating surveillance of only user 2.

Continuing on to FIG. 6, at 601, it is assumed that the local node 411 and Admin Function 403 share a counting Bloom filter that establishes surveillance of only UE 2 632 (and not for UE 1 631 or UE 3 633). In this MSC, each of the possible cases is explored. A false negative is not explored since it is not feasible with a properly designed counting Bloom filter.

Steps 602, 603, and 604 cover the case of a true negative. A true negative occurs when the counting Bloom filter correctly indicates that a user is not the target of surveillance. In this case, that user is UE 1.

In step 602, UE 1 631 attaches to the network as defined by the 3GPP standard.

In step 603, the local node 411 tests the ID of UE 1 631 against the counting Bloom filter. It does so by hashing the ID using the defined hash functions and comparing the results against the counting Bloom filter received from the Admin Function. In this case, there is no match, representing a true negative.

In step 604, the UE begins a data session which is offloaded by the local node directly to the application server 635 on the public Internet. It should be noted that the local node is not forwarding data via the X2 or X3 interfaces to the DF 2 and DF 3 functions 413 415 in the core network 401.

Steps 605 through 610 cover the case of a true positive. A true positive occurs when the counting Bloom filter correctly indicates that a user is the target of surveillance. In this case, that user is UE 2 632.

In step 605, UE 2 attaches to the network as defined by the 3GPP standards.

In step 606, the local node tests the ID of UE 2 against the counting Bloom filter. It does so by hashing the ID using the defined hash functions and comparing the results against the counting Bloom filter received from the Admin Function. In this case, there is a match, representing a true positive.

In step 607, the UE 2 begins a data session which is offloaded by the local node 411 directly to the application server 635 on the public Internet.

In step 608, the local node 411 begins forwarding any intercept related information and a copy of the data to the DF 2 and DF 3 functions 413, 415 in the core network 411 using the X2 and X3 interfaces.

In step 609, the DF 2 and DF 3 functions check to ensure that this user is indeed a target of surveillance. It can check the ID of the user against an actual list of the IDs of the targets of surveillance stored in the Admin Function 403 (i.e., the list of IDs, not the counting Bloom Function).

In step 610, after determining that the user is indeed the target of surveillance, the DF 2 and DF 3 functions forward any intercept-related information and a copy of the data to the LEA 407 over the existing HI 2 and HI 3 interfaces as defined in the 3GPP standards.

Steps 611 through 615 cover the case of a false positive. A false positive occurs when the counting Bloom filter incorrectly indicates that a user is the target of surveillance. In this case, it is assumed that the ID of UE 3 634 coincidentally hashes to one of the values set in the counting Bloom filter, yielding a false positive.

In step 611, UE 3 attaches to the network as defined by the 3GPP standards.

In step 612, the local node 411 tests the ID of UE 3 634 against the counting Bloom filter. It does so by hashing the ID using the defined hash functions and comparing the results against the counting Bloom filter received from the Admin Function. In this case there is a match, representing a false positive.

In step 613, the UE 3 634 begins a data session which is offloaded by the local node 411 directly to the application server 635 on the public Internet.

In step 614, the local node begins forwarding any intercept-related information and a copy of the data to the DF 2 and DF 3 functions 413, 415 in the core network using the X2 and X3 interfaces.

In step 615, the DF 2 and DF 3 functions check to ensure that this user is indeed a target of surveillance. As before, it can check the ID of the user against the actual list of the IDs of the targets of surveillance in the Admin Function (not the counting Bloom filter). Since there is no match, meaning UE 3 634 is not the target of surveillance, the DF 2 and DF 3 functions 413, 415 will drop the data and not send it to the LEA.

### 1.5 Example

In the following example, International Mobile Subscriber Identities (IMSIs) of users will be hashed using a simple hash function to populate a counting Bloom filter data structure. This example will illustrate the logic defined previously in this specification.

IMSIs are composed of 15 digits, comprising a three digit country code, a three digit network code, and a nine digit subscriber ID. For a given network, the country code and network code would be the same and the subscriber ID is used to differentiate among the different subscribers. For this example, there are five subscribers to the network, with the following IMSI values:
310420123456789
310420214365879
310420223456789
310420334456789
310420445566788

A single simple hash function will be used that starts with a seed and exclusive ORs each digit of the IMSI with the seed. After all 15 digits have been “hashed”; the result is the value in the counting Bloom filter data structure that will be set (or incremented, if a counting Bloom filter). The counting Bloom filter will only have 16 values, 0x0 to 0xF.

Assuming an initial seed of 0x0 for each, Table 1 below shows the hash values for each IMSI.

TABLE 1

| Subscriber | IMSI | Hash Value |
|---|---|---|
| 1 | 310420123456789 | 0x5 |
| 2 | 310420214365879 | 0x5 |
| 3 | 310420223456789 | 0x6 |
| 4 | 310420334456789 | 0x1 |
| 5 | 310420445566788 | 0x4 |

Notice that the first two IMSIs hash to the same value. This will obfuscate who is and who is not a target of surveillance.

If the first and fifth subscribers are the target of surveillance, the LEA will inform the Admin Function of this via the HI 1 interface. The Admin Function will resolve the subscriber identity to the first and fifth IMSIs and will compute the hash value of each. Once computed, the Admin Function will update the Bloom filter data structure. It is assumed that, prior to this step, the counting Bloom filter is all zeroes, meaning there are no targets of surveillance. For this case, the counting Bloom filter data structure would be as shown in Table 2 below.

TABLE 2

| Hash Value | Occurrences |
|---|---|
| 0 | 0 |
| 1 | 0 |
| 2 | 0 |
| 3 | 0 |
| 4 | 1 ← For the first subscriber |
| 5 | 1 ← For the fifth subscriber |
| 6 | 0 |
| 7 | 0 |
| 8 | 0 |
| 9 | 0 |
| A | 0 |
| B | 0 |
| C | 0 |
| D | 0 |
| E | 0 |
| F | 0 |

Once computed, this counting Bloom filter data structure will be sent to the local node using the X1-1 interface between the Admin Function and the local node. Upon receipt, the local node would store this in its TrE. The local node will have also been previously informed of the hash function and the initial seed to be used.

First, the true positive is discussed. Within the local network, controlled by the local node, the fifth subscriber attaches to the network. Upon attachment, the local node, within its TrE, will hash this subscriber's identity. In this case, the result will be 0x4. The local node will compare this result with the Bloom filter data structure and note the match. The local node will then begin forwarding Intercept Related Information (IRI) and Content of Communications (CC) to the DF 2 and DF 3 elements 413, 415 within the core network 401 for any offloaded IP Flow. Upon receipt of the IRI and CC by the DF 2 and DF 3 in the core network, functionality on the core network will confirm that the user is indeed under actual surveillance (by comparing the IMSI to the list of IMSIs for those users who are the target of surveillance as opposed to comparing against the counting Bloom filter data structure). In this case, since this check will confirm that the user is a target of surveillance, the Admin Function 403 will forward the IRI and CC to the LEA 407 via the HI 2 and HI 3 interfaces.

Next, the true negative is discussed. Within the local network, controlled by the local node, the fourth subscriber attaches to the network. Upon attachment, the local node 411, within its TrE, will hash this subscriber's identity. In this case, the result will be 0x1. The local node will compare this result with the counting Bloom filter data structure 417 and note the absence of a match. Hence, the local node will not forward IRI and CC for this user's IP Flows to the DF 2 and DF 3 elements within the core network.

Finally, the false positive is discussed. Within the local network, controlled by the local node, the second subscriber attaches to the network. Upon attachment, the local node, within its TrE, will hash this subscriber's identity. In this case, the result will be 0x5 (which happens to be the same hash value received when hashing the first subscriber's IMSI, the first subscriber actually being a target of surveillance). The local node 411 will compare this result to the counting Bloom filter data structure 417 and note the match. The local node will then begin forwarding IRI and CC to the DF 2 and DF 3 elements 413, 415 within the core network for any offloaded IP Flow. Upon receipt of the IR and CC by the DF 2 and DF 3 in the core network, it will attempt to confirm that the user is the target of surveillance. Since the IMSI of the second subscriber is not the target of surveillance (i.e., not in the list of IMSIs of those users under surveillance), the DF 2 and DF 3 functions discard the forwarded data and do not send it to the LEA 407.

Given the selection of IMSIs, the simplicity of the hash and the very narrow size of the data structure, there is likely to be a high level of collisions (i.e., several IMSIs that hash to the same value). It will be understood that, in a more practical deployment, a much larger counting Bloom filter with a “better” hash function, such as Fowler-Noll-Vo, likely could be used, thereby reducing the number of collisions.

While the above solution and example use a counting Bloom filter, the same logic applies to the use of a basic Bloom filter. The only exception is that, with a basic Bloom filter, once added to the basic Bloom filter, it is not possible to remove a user. However, leaving a deleted user in the basic Bloom filter for a short time will normally be acceptable, since such would simply be analogous to a false positive, and the DF 2 and DF 3 functions will verify whether or not a user actually is still a target of surveillance. As described above, if so, then the DF 2 and DF 3 functions will forward the IRI and CC to the LEA. If not, then the DF 2 and DF 3 functions will not forward the IRI and CC to the LEA.

Alternatively, the deletion of a target of surveillance with a basic Bloom filter could be handled by having the Admin Function 403 reconstitute the basic Bloom filter data structure without the hashed value of the specific user ID who was no longer the target of surveillance. It could do so by rehashing the IDs of the subscribers who are still the targets of surveillance and placing the hashed values in the basic Bloom filter.

### 1.6 Scalability

In this section, the scalability of the solution is evaluated for either a counting or basic Bloom filter.

A mobile operator may have upwards of 100 million subscribers [10]. While it is unknown how many of the users may be under surveillance at any one time, if 0.1% of subscribers are under surveillance, that would equate to 100,000 subscribers, or 100,000 IMSIs that would have to be hashed and placed into a Bloom filter data structure. Each element in the counting Bloom filter data structure would have a count of how many IMSIs hashed to that value. It is expected that a great deal of the data structure would be zeroes.

Since law enforcement and operators do not advertise the number of users under surveillance, the 0.1% is an anecdotal quantity. In practice, and at any given time, the number could be higher or lower.

The probability of a collision within either a counting or basic Bloom filter data structure is given by the following equation [11]:

$$p = {( 1 - {e}^{\frac{- kn}{m}} )}^{k}$$

where:
k is the number of hash functions used
n is the number of objects to be placed in the data structure
m is the number of elements in the data structure

For an operator with a subscriber base of 100 million users, with a 0.1% surveillance rate, either a counting or basic Bloom filter could be designed using the following parameters:
k=1 hash functions
n=100,000 elements (IMSIs of users under surveillance)
m=1,048,576=128 Kbytes (basic Bloom filter size)

With these values, the probability of a collision, p, is approximately 9%.

Networks with a smaller subscriber base could use a smaller Bloom filter and achieve similar false positive probabilities. Alternatively, if more subscribers are the target of surveillance, the Bloom filter size could be expanded. For a counting Bloom filter, if a 1 byte counter is used for each entry, the size would be 1 Mbytes.

For either a counting or basic Bloom filter, transferring the entire Bloom filter to the local node upon each and every update may prove burdensome to the backhaul link between the local node and the Admin Function. Two techniques to reduce this overhead are proffered here. In the first, the Bloom filter is compressed. In the second, only the updates are sent to the local node, and the local node maintains the actual Bloom filter. Each solution can be used with either a counting or basic Bloom filter.

1.6.1 Compression

The size of the Bloom filter sent to the local node can be minimized. In [12], it is noted that, once a Bloom filter is obtained (i.e. after adding n elements in the m-bits Bloom filter using k hash functions), this Bloom filter can be passed through a compressor, to obtain z bits, i.e. z/n per element in the Bloom filter. The paper [12] does not prescribe a compressor but uses a specific publicly available compressor for the simulations presented in the paper. In an example (using Table 1 of [12]), we can limit the transmitted bits to z/n=8 using k=2 hash functions, yielding a 1.77% probability of a false positive. In our example of 100 million users, with a 0.1% surveillance rate, i.e., n=100,000, this would result in z=100 KB transmitted to the local node to send the Bloom filter. Note that, in this example, the actual Bloom filter size is min=14, i.e. m=1,400,000 and bits=171 KB. Thus, the uncompressed Bloom filter is about 70% larger than what is transmitted in the compressed data.

While the above calculations pertain to the initial transfer, we can further reduce the size of the transmitted data when transferring small changes to the Bloom filter by calculating an XOR of the old and new Bloom filters and passing the result through an arithmetic compressor algorithm. The result can be transmitted to the local nodes, which apply the reverse operations to update their copy of the old Bloom filter into the new Bloom filter. This operation is also described in [12]. In an example from [12] close to the above example (m/n=13, i.e. m=160 KB, which is similar to the above where m=171 KB), we can achieve z/n=1.3 to transfer a Bloom filter changed by 5% (see Table 6 of [12], in which k=2, m/n=13, P=2%), and z/n=0.34 to transfer a Bloom filter that is changed by 1%. This results in transfers of approximately 16 KB and 4 KB, respectively, for 5% and 1% changes. A 1% change of the n=100,000 entries is 1,000. Therefore, two possibilities are to send updates every 10 minutes or as soon as 1,000 entries are added or removed (in total). The latter would ensure that updates stay below 4 KB. Another exemplary option is to send updates every 10 minutes or as soon as 1,000 entries are added or removed, whichever occurs first.

To summarize, a more optimized example is presented. The goal is to limit p to an upper bound of approximately a 2% false positive rate under the following assumptions:
Use of 2 hash functions (k=2);
a network with 100 million subscribers; and
a 0.1% surveillance rate

For this example, we need to transmit the whole Bloom filter (in a compressed form) once as a 100 KB object. Thereafter, the periodically transmitted updates will require about 4 KB. The amount of memory required by each local node to maintain a copy of the Bloom filter is less than 200 KB.

In one embodiment, the method of sending the compressed Bloom filter to the local node 411 from the Admin Function 403 will follow the following steps. The Admin Function 403 will compute the compressed Bloom filter as described above. Once it is calculated, the Admin Function will dispatch the compressed Bloom filter to the local node 411 using the X1-1 interface. Upon receipt, the local node will decode the Bloom filter. Finally, the local node will replace the current compressed Bloom filter in the local node with the one just received from the Admin Function. The local node will then continue using the just received new Bloom filter.

1.6.2 Local Node Maintains Bloom Filter

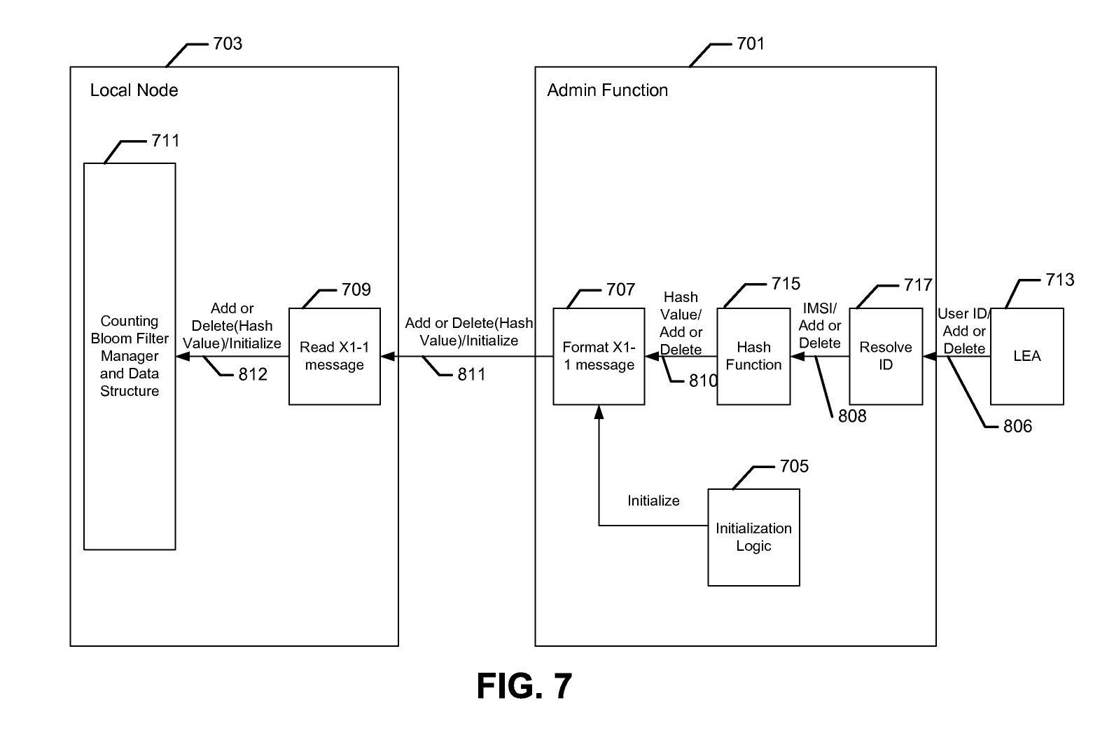

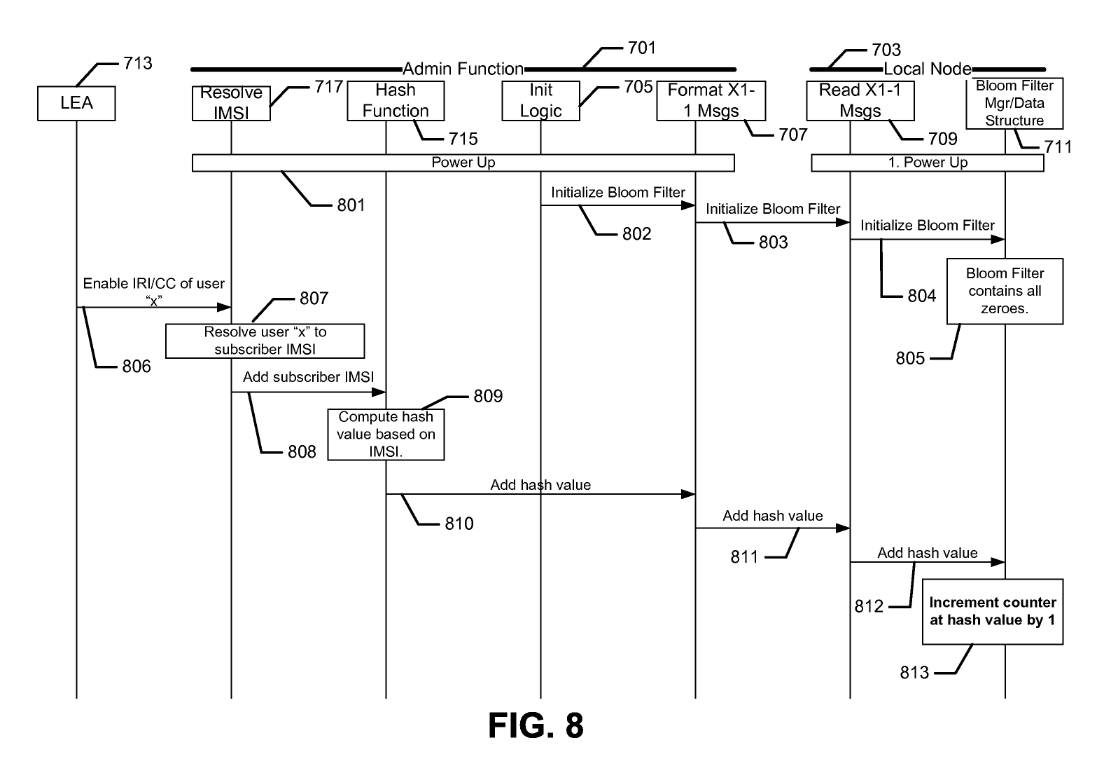

If the transfer of the entire Bloom filter upon each and every update is not acceptable, the base Bloom filter data structure instead may be stored at the local node and the Admin Function dispatches updates (additions or deletions) to the local node, rather than transferring the entire data structure whenever it is changed. The topology for this solution is shown in the topological diagram of FIG. 7 and a MSC is shown in FIG. 8.

In step 801 (FIG. 8), the Admin Function 701 (see FIGS. 7 and 8) and the local node 703 are both powered up. It should be appreciated that there may be some signaling between the Admin Function 701 and the local node 703 to discover and mutually authenticate each other that is not shown in these FIGS. Exemplary discovery and authentication techniques can be found in aforementioned U.S. Published Patent Application No. 2013/0326631.

In step 802, the initialization logic 705 within the Admin Function 701 informs the logic that formats X1-1 messages (logic 707) to send an initialization message to the local node.

In step 803, the X1-1 message formatting logic 707 formats the message and sends it to the local node 703.

In step 804, the logic 709 within the local node 703 that processes the received X1-1 messages forwards the received initialization message to the Bloom filter functionality 711 in the local node 703.

In step 805, the Bloom filter 711 within the local node is initializes itself to all zeroes.

At some point thereafter, as shown in step 806, a law enforcement agency 713 will command the Admin Function 701 within the core network to enable lawful interception of a particular user, in this instance user “x”. This is an existing step already defined by the 3GPP standards [13].

In step 807, a Resolve ID function 717 within the Admin Function 701 determines the IMSI that maps to user “x”.

In step 808, the Hash function 715 within the Admin Function 701 receives the subscriber's IMSI along with an indication to enable surveillance on this user.

In step 809, the Hash function 715 computes the hash value using the IMSI as input.

In step 810, the Hash function 715 pushes the hash value computed in step 809 to the logic 707 that formats the X1-1 messages. As part of this step, the Hash function indicates that surveillance is to be activated for this hash value.

In step 811, the message format logic 707 pushes this message to the local node 701 using the physical interface between the Admin Function 703 and the local node 701.

In step 812, the local node 703 receives this message and pushes it to the Bloom filter functionality 711 within the local node 703.

In step 813, the Bloom filter functionality 711 increments the counter associated with the hash value received from the Admin Function 701 since the message received from the Admin Function was to enable surveillance.

The use of the Bloom filter values after being updated remotely by the Admin Function 701 as described above is identical to that described previously and, thus, is not described further in this discussion.

If surveillance is to be enabled for other users, steps 806 through 813 may be repeated for each such user.

For a basic Bloom filter, the same basic steps could be followed.

For a basic Bloom filter using the compressed method described above, steps 810, 811 and 812 could use a compressed update message. Step 813 could be an uncompress and XOR operation.

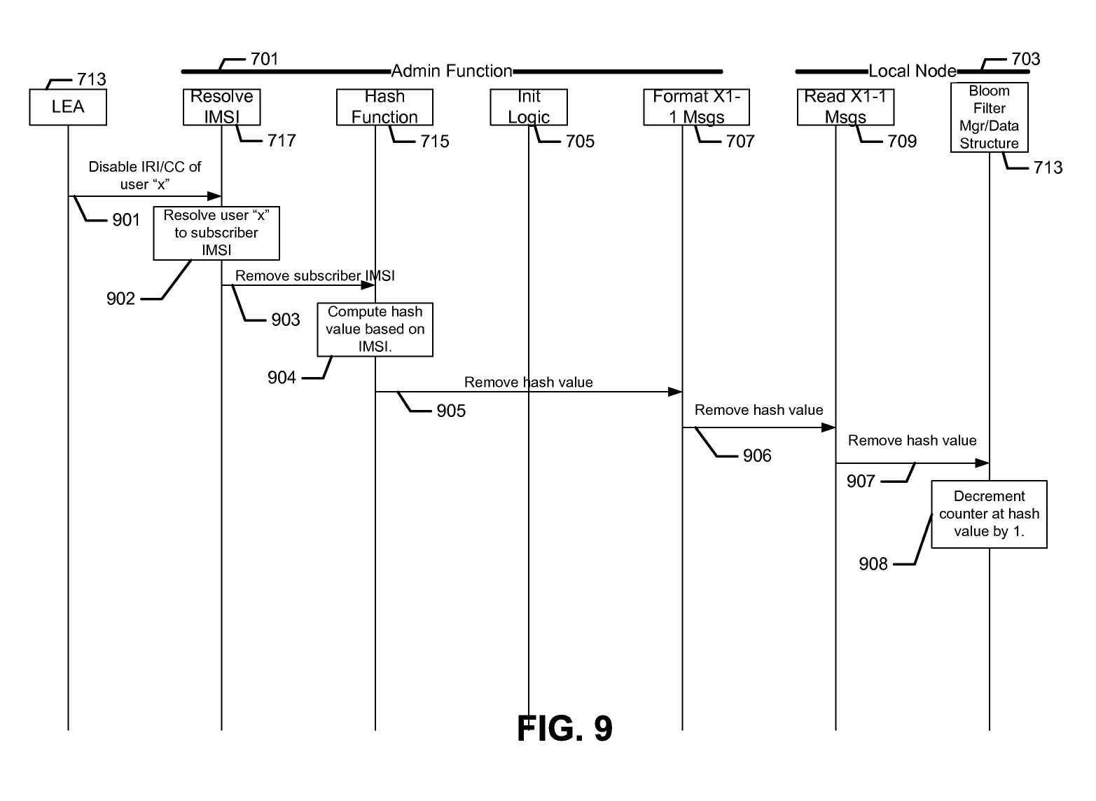

FIG. 9Error! Reference source not found. is another MSC that illustrates signal flow for when a previously enabled surveillance is disabled by law enforcement. In step 901, law enforcement 713 directs the Admin Function 701 to disable the surveillance that was enabled previously.

In step 902, logic 717 converts the user identification to an IMSI.

In step 903, the Hash function 715 within the Admin Function 701 receives the subscriber's IMSI along with an indication to disable surveillance on this user.

In step 904, the Hash function 715 computes the hash value using the IMSI as input.

In step 905, the Hash function 715 pushes the hash value computed in step 904 to the logic 707 that formats the X1-1 messages. As part of this step, the Hash function will indicate that surveillance is to be deactivated for this hash value.

In step 906, the message format logic 707 pushes this message to the local node 703 using the physical interface between the Admin Function 701 and the local node 703.

In step 907, the local node 703 receives this message and pushes it to the Bloom filter functionality 713 within the local node 703.

In step 908, the Bloom filter functionality 713 decrements the counter associated with the hash value received from the Admin Function (since the message received from the Admin Function was a message to disable surveillance).

The use of the Bloom filter values after being updated remotely by the Admin Function is identical to that described previously and is omitted from this discussion.

If surveillance is to be disabled for other users, steps 901 through 908 may be repeated for each such user.

For a basic Bloom filter, FIGS. 7 and 8 can be merged into a single “update” procedure.

While not shown in these steps, it is anticipated that an acknowledgement may be required between the Admin Function 701 and the local node 703 to ensure the data structure remains correct. For example, if a command sent from the Admin function to add or delete a subscriber from the data structure is not correctly received by the local node, then the Bloom filter in the local node would not be accurate. Thus, the messaging may be designed such that each command from the Admin Function requires an acknowledgement from each local node. Failure to receive this acknowledgment should cause the Admin Function to retransmit the command.

### 2. PROVISIONING

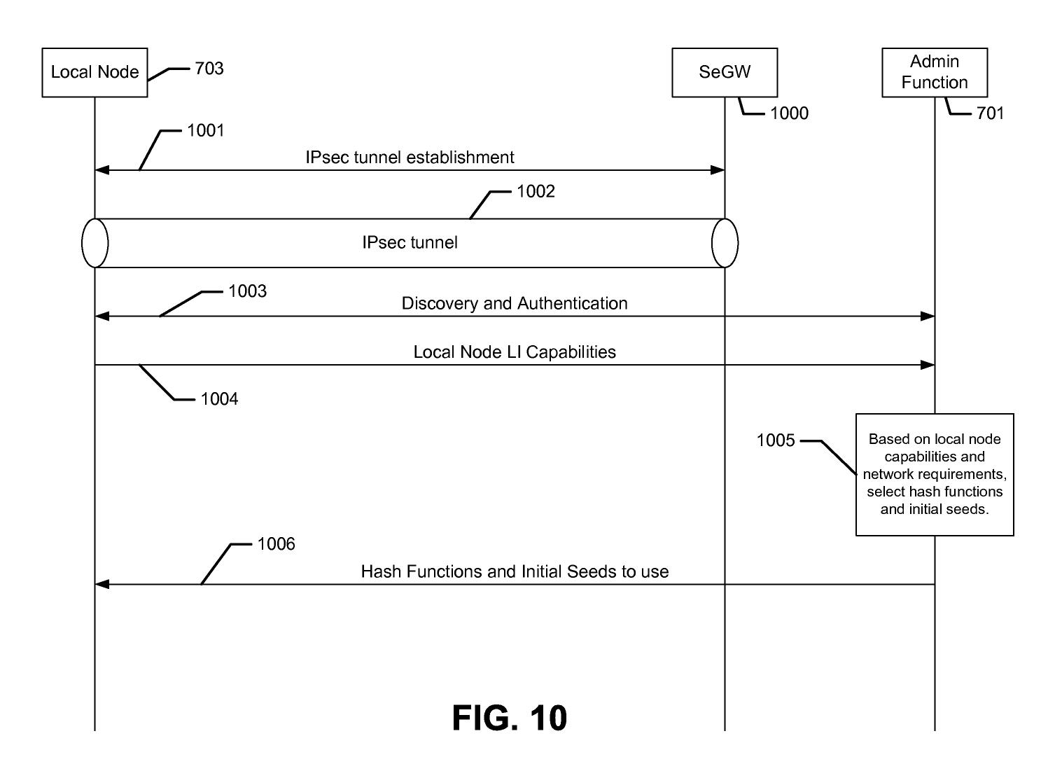

The local node and Admin Function within the core network should be synchronized as to which hash functions to use and, in some instances, as to the initial seed for some hash functions. Furthermore, the size of the Bloom filter and whether it is a counting or basic Bloom filter also should be synchronized. It is expected that, when the LI function within the local node and the Admin Function initially communicate, they will communicate which hash functions will be used and the values of any initial seeds, if needed. It should be understood that while this interaction is shown between the local node and the Admin Function, another node in the core network could be used for this provisioning, such as a H(e)NB Management System (H(e)MS). As such, the interaction shown in this section is functional, and could be performed in any node in the core network. It also should be understood that this provisioning interaction may be done over the (existing) secure interface between the local node and the Secure Gateway (SeGW) at the edge of the mobile core network. This is typically secured via an IPsec tunnel An MSC for this provisioning in accordance with one exemplary embodiment is shown in FIG. 10Error! Reference source not found.

In step 1001, the local node 703 and SeGW 1000 at the edge of the mobile core network establish a secure connection, using, for example, IPsec as defined in the 3GPP standards, as shown at 1002.

In step 1003, a discovery and mutual authentication process occurs. This process allows the local node 703 to find the Admin Function 701 and allows them to each mutually authenticate that the other as a trusted node. This step is described in more detail in aforementioned U.S. Published Patent Application No. 2013/0326631. It should be understood there may be other methods to perform the mutual authentication in addition to those in the noted reference.

In step 1004, the local node 703 reports its capabilities. This message may be sent over the X1-1 interface between the local node 703 and Admin Function 701. It may include the following fields:
Basic Bloom filter supported;
Counting Bloom filter supported;
Maximum Size of Bloom filter;
List of supported Hash Functions.

If the local node does not support Bloom filters, both the basic and counting fields will be set to false. The local node could support both, in which case the network will determine which to use. The maximum Bloom filter size will indicate the largest sized Bloom filter that the local node can support. If that is deemed to be too small by the Admin Function, it may decide to not use Bloom filters. The Admin Function may also decide to employ a Bloom filter smaller than the maximum supported by the local node. It is expected that the Admin Function will support a wide suite of hash functions. It is expected that a local node will support a subset or proper subset of the hash functions supported by the Admin Function.

In step 1005, the Admin Function will parse the message received from the local node 703 in step 1004. If the local node does not support Bloom filters, then the Admin Function 701 will not use them. If the local node supports only basic Bloom filters, then the Admin Function may use a basic Bloom filter. In one embodiment, if the local node supports only counting Bloom filters or both counting and basic Bloom filters, then the Admin Function will use a counting Bloom filter.

If the maximum size of the Bloom filter supported by the local node is less than that required by the Admin Function, then the Admin Function will not use Bloom filters. If the maximum size of the Bloom filter supported by the local node is sufficient, then the Admin Function may use Bloom filters and will determine the optimal mix between the number of elements in the Bloom filter and the size of the counting buckets if a counting Bloom filter is used.

If the number of hash functions supported by the local node is less than the minimum required by the Admin Function, then the Admin Function will not use Bloom filters. Otherwise, the Admin Function may use Bloom filters and can select the number of hash functions that the Admin Function deems sufficient.

In step 1006, the Admin Function 701 commands, via the X1-1 interface, the local node 703 as to the specifics of the processing for the selected Bloom filter. This message may include, for instance:
Counting Bloom filter Used;
Basic Bloom filter Used;
Total size of Bloom filter;
Number of elements in Bloom filter;
Size of counting bucket for Counting Bloom filter; and
List of Hash Functions to be used and initial seed for each.

### 3 APPLICABILITY TO OTHER MEDIUMS

The solutions defined herein are shown for an LTE network. These solutions may also be applied to other technologies as well, such as an 802.11 network, a WiMax network, GSM, UMTS as well as other experimental technologies such as Dynamic Spectrum Management (DSM).

### 4 FURTHER ALTERNATIVES

There are several additional alternatives to the systems and embodiments proposed hereinabove. For instance, filters other than Bloom filters may be used. In addition, the techniques, systems, methods, and embodiments disclosed herein may be used in connection with offload in contexts other than or in addition to LI. For example, a Bloom filters for surveillance could be augmented with those users who are not permitted to be offloaded based on policy or level or service purchased. Such additions are further beneficial in that they may further obfuscate who is and who is not the target of surveillance.

More broadly, the techniques, apparatus, methods, and embodiments disclosed herein may be user to identify any particular group of users of a telecommunications network using a Bloom filter or any of the alternatives thereof mentioned herein. Furthermore, membership in the particular group of users may result in processing of data flows involving the first user in any particular manner that is different from the processing of data flows of users who are not part of the group.

### 4.1 Alternate Filters

Examples of approximate membership queries (AMQs) that may be used instead of Bloom filters include:
Quotient Filters;
Bloomier Filters;
Other Bloom filters, such as Attenuated Bloom filters, Scalable Bloom filters, etc.

Any of the above listed filters or any other AMQ could be used in place of the Bloom filter to achieve the same results.

### 4.2 Co-Mingled Lawful Interception, Policy, and Random Users

In this exemplary alternative embodiment, the Bloom filter data structure may be populated with users chosen based on multiple criteria, e.g., some users are on the list for LI purposes, others are on the list as a result of policy considerations (such as level of service paid for), and yet other users are randomly listed in order to further obfuscate the true targets of LI. In such embodiments, the Bloom filter data structure located within the core network may be populated by any one or more of:
the Admin Function (as described earlier herein);
a Policy Engine;
a process that randomly selects users.

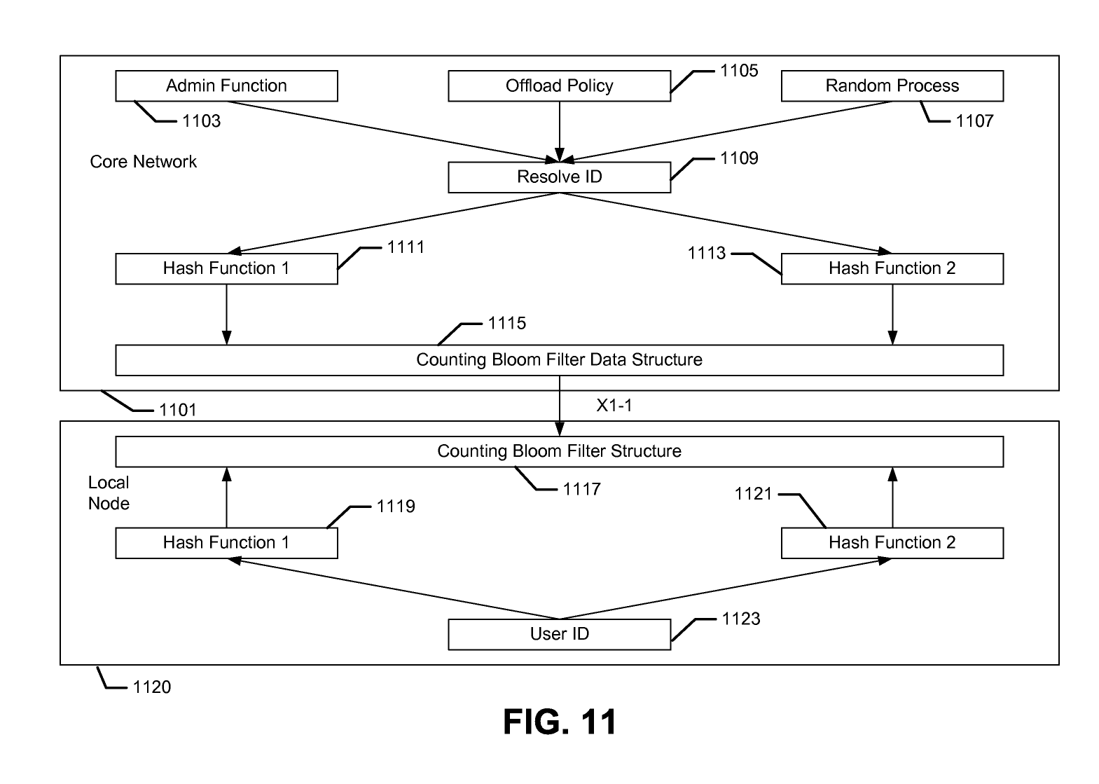

Either a basic or a counting Bloom filter may be used. An exemplary topology using a counting Bloom filter is shown in FIG. 11. Where a basic Bloom filter would or might require unique processing, it is noted in the text.

In this topology, the Admin Function 1103, the Policy Engine 1105, or the Random Process 1107 can insert or delete a particular subscriber ID in the counting Bloom filter data structure (of which there are two copies, copy 1115 in the core network 1101 and copy 1117 in the local node 1120). In this exemplary topology, if the local node 1120 determines that a user ID, once hashed, is in the counting Bloom filter data structure, the local node will not offload any new IP Flows for that user. That is, in contrast to most of the previously described embodiments, in which, if a user ID is a surveillance target, the local node copies the data to the Admin Function in core network, in this embodiment, the local node simply does not allow offload from the core network so that all of the traffic for a user that is under surveillance passes through the core network and can be surveilled within the core network conventionally. This mode of operation could be applied to any of the previously described embodiments also.

If there are any existing IP Flows for this user that are being offloaded when the local node determines that the user ID is in the counting Bloom filter, they may continue being offloaded, but the IRI and CC for these IP Flows should be forwarded to the DF 2 and/or DF 3 entities within the core network as previously described.

Since there are three sources of insertion into the counting Bloom filter in this embodiment, namely, Admin Function 1103, Offload Policy Engine 1105, and Random User Process 1107, it is not known at the local node 1120 which one of the three sources actually inserted a specific subscriber ID into the Bloom filter data structure. So, even if an unauthorized entity at the local node can deduce that a specific user ID is in the counting Bloom filter, such entity would not know which of the three sources actually placed the subscriber ID in the counting Bloom filter. Note that even determining that the user is in the counting Bloom filter requires the unauthorized entity to break into the TrE to extract the counting Bloom filter (or decode the encrypted signals between the core network and local node), know what hash function(s) are used in the TrE, and know what seeds are used in the hash function.

It should be understood that, while the above alternative is shown with all three functions (the Admin Function 1103, the Policy Function 1105, and the Random Process 1107), using either the Policy Function or the Random Process and omitting the other is possible. On the other hand, it also is possible to add even further functions and policies for specifying users for inclusion in the Bloom filter data structure.

The Admin Function 1103 in this embodiment may work as described in the previous sections. It may insert and delete subscriber IDs into/from the counting Bloom filter 1115 maintained in the core network. It may interface with the LEAs as defined within the standards, being commanded to enable or disable surveillance of specific users. If a user is the target of surveillance (enabled by a LEA), then the Admin Function 1103 will hash that subscriber ID using the hash functions 1111, 1113 and add the hashed value to the counting Bloom filter 1115. If a user is no longer the target of surveillance (disabled by a LEA), then the Admin Function 1103 will remove the hashed value from the counting Bloom filter 1115. Note that, by adding and deleting, the counter at each entry in the counting Bloom filter is either incremented or decremented, respectively.

These same operations can be performed with a basic Bloom filter as well. Specifically, the Admin Function 1103 may maintain a list (which can be encoded as a structure like a hash table or tree) of all entries, associated with pre-calculated hash values. The add/remove operations are on this list. The Admin Function may then assemble the basic Bloom filter when needed (e.g., periodically or each time an entry is added), and cache the old value of the basic Bloom filter to enable XORing of the old and new.

The Policy Function 1105 should have access to the policies applied to users. The form and nature of the policies could be anything. The policies could be applicable to specific individual users or groups of users and could be of the form defined in [14]. The policies, in whatever form, will allow for the resolution of whether or not to allow local offload for a specific subscriber identity. Merely as a few examples, the user may have traffic offload enabled or disabled based on location, time of day, or network conditions.

The Policy Function 1105 may periodically access the policy or may access the policy asynchronously based on the occurrence of a particular event. On the first occasion of the Policy Function 1105 accessing the policy information, the Policy Function will hash the subscriber ID of each subscriber who is prohibited from using local offload and update the counting Bloom filters 1115, 1117 using the hash value for each prohibited subscriber. Thereafter, on any subsequent access of the policies by the Policy Function, the Policy Function will determine which subscribers have a change of state, either from local offload enabled to disabled, or local offload disabled to enabled. For those subscribers whose policy transitioned from enabled to disabled, the Policy Function can compute the hash value and add it to the counting Bloom filter. For those subscribers whose policy transitioned from disabled to enabled, the Policy Function can compute the hash value and delete it from the counting Bloom filter 1115. As an alternative, the Policy Function 1105 may be located at the local node 1120.

These operations may be performed as well using a basic Bloom filter. The Policy Function 1105 maintains a list (which can be encoded as a structure like a hash table or tree) of all entries associated with pre-calculated hash values. The add/remove operations are on this list. The Policy Engine Function then assembles the basic Bloom filter when needed (e.g., periodically or each time an entry is added), and caches the old value of the basic Bloom filter so that it can later XOR the old and new Bloom filters, such as when needed to transmit Bloom filter update information to the local node efficiently as previously discussed.

The Random Process 1107 may periodically disable (and subsequently enable) local offload for random subscribers. The duration of the disable may be random in nature (e.g., to emulate the duration of the surveillance of a subscriber by a LEA). The random duration can be normal, uniform, or any other distribution. The number of subscribers to be disabled at any one time may be configurable and will most likely be a constant. The periodicity of this process can be constant or can vary. When the Random Process decides to disable local offload for a specific user, it will compute the hash value using that subscriber ID and add it to the counting Bloom filter. When the Random Process decides to re-enable local offload for a previously disabled specific user, it will compute the hash value using that subscriber ID and remove it from the counting Bloom filter. As an alternative, the Random Process could be located at the local node and configured by the Admin Function via the X1-1 interface.

If using a basic Bloom filter, these operations can be performed as well. Specifically, the Random Process 1107 may maintain a list (which can be encoded as a structure like a hash table or tree) of all entries, associated with pre-calculated hash values. The add/remove operations are on this list. The Random Process then assembles the basic Bloom filter 1115 when needed (e.g., periodically or each time an entry is added), and caches the old value of basic Bloom filter to enable XORing of the old and new.

It is possible that any two or all three of the processes 1103, 1105, 1107 might add the same subscriber to the common counting Bloom filter 1115. If this occurs, the counter at that entry within the Bloom filter will be incremented each time. Therefore, it may be required that each entity is responsible for managing whichever entries it adds to the counting Bloom filter, meaning that the deletion of that entry is the responsibility of the entity that originally added it. Hence, in the case where all three processes 1103, 1105, 1107 insert the same particular subscriber into the counting Bloom filter so that the count at the corresponding location of the counting Bloom filter is 3, if the Policy Engine and the Random Process decide to remove the subscriber, they would do so by decrementing the counter at that entry in the counting Bloom filter, leaving it at 1. Doing so, would still leave the Admin Function addition of the particular subscriber in the counting Bloom filter, signified by the value of 1 in the counter at the corresponding entry in the counting Bloom filter.

If using a basic Bloom filter, each of the above processes would compute their own copy of the basic Bloom filter and it would be ORed before it was sent to the local node.

For all three functions (in either the basic or counting Bloom filter cases), if it is determined that the hash functions are too costly to compute dynamically, they can be computed a priori and stored with the subscriber ID of each user within the core network. This allows for the saving of resources within the core network, not requiring the dynamic computation of hash values in real-time.

Embodiments in which the Random Process excludes random subscribers from local offload arguably introduce inefficiency in the system as a whole. To wit, the traffic of several users who may be eligible for local offload will not be locally offloaded and will traverse the mobile core network. Any such inefficiency is the cost for allowing local offload to exist while still meeting LI requirements. However, other users can be offloaded in the place of those users that cannot be offloaded due to any LI concerns, thereby substantially reducing, if not entirely eliminating, any such inefficiencies. Overall, the benefit of allowing local offload for almost all of the eligible subscribers outweighs disabling this feature for a handful of eligible users (i.e., users who are not targets of surveillance and who should be allowed to perform local offload based on policy).

An example is presented to explain this concept. For this example, there are 50 assumed subscribers that are attached to a small cell network. In this small cell network, each subscriber has a unique IMSI. Any of these users could be the subject of surveillance from law enforcement (e.g., LI), could be subject to a policy which forbids local offload, or could be selected by the Random Process for prohibition of local offload. For this example, it is assumed that 2 of these users are targets of surveillance. It is also assumed in this example that 5 of these users are not eligible for local offload based on some other policy and that the remaining 45 users are eligible for local offload. It is further assumed that the Random Process will randomly select 2 users at any given time to prohibit from local offload. Since users are independently selected for each group (surveillance, policy, or random), it is possible that a user could fall into none, one, two, or all three categories. In addition, there are false positives for each of these groups inherent in the Bloom filter data structure.

This example will use a 64 element counting Bloom filter. Given the size of the Bloom filter (64 elements) and the number of subscribers added into the Bloom filter (minimum of 5, maximum of 9), as well as the number of hash functions (1), the probability of a false positive within the Bloom filter will be between approximately 7.5% (for n=5, m=64, k=1) and 13% (for n=9, m=64, k=1) using the equation offered earlier in this specification.

If a user is barred from offload, there are four possible causes, namely:
Subscriber ID is target of surveillance;
Subscriber ID is prohibited by policy;
Subscriber ID was randomly selected; and
Hash of subscriber ID yields a false positive

Then, for this example, we have the following probabilities:

$$P ( Surveillance Target ) = \frac{2}{50} = 4 \%$$

$$P ( Prohibited by Policy ) = \frac{5}{50} = 10 \%$$

$$P ( Random Process ) = \frac{2}{50} = 4 \%$$

$$7.5 \% < P ( False Positive ) < 13 \%$$

Assuming that the users barred by policy, those selected randomly, and those who are subject of surveillance are mutually exclusive, then the probability for a specific user not being allowed to offload their traffic is given by:

P(Offlood Disabled)=ΣP(x)

Where “x” is prohibited by policy, random, target of surveillance, or a false positive. In this case:

25.5%<P(Offload Disabled)<31%

So, between one third and one quarter of the users will have offload disabled as a result of at least one of the four causes (policy, random, surveillance, or false positive).

The benefit of adding the policy and randomness into the Bloom filter data structure (and the use of the Bloom filter false positives) can be evidenced by examining the conditional probability [15] of a particular subscriber whose traffic is not being offloaded actually being a target of surveillance.

$$P ( Surveillance Target \text{\textbar} Offload disabled ) = \frac{P ( Surveillance Target and Offload Disabled )}{P ( Offload Disabled )}$$

Those subscribers whose offload is disabled as a result of surveillance is a proper subset of all subscribers whose offload is disabled. Consider that, if a subscriber is the target of surveillance, offload is disabled for that subscriber. Further consider that there is a group of subscribers who have offload disabled for other reasons. Hence, the subscribers for whom offload is disabled because of surveillance is a subset (at worst a proper subset) of those subscribers who have offload disabled for all reasons. Based on this, the equation describing the ratio of subscribers actually subject to LI versus subscribers prohibited from offload becomes:

$$P ( Surveillance Target \text{\textbar} Offload disabled ) = \frac{P ( Surveillance Target )}{P ( Offload Disabled )}$$

In the case described above, where we assume no overlap between the different user groups who are barred from offload, the result is:

$$P ( Surveillance T arget \text{\textbar} Offload disbaled ) = \frac{4 \%}{31 \%} = 12.9 \%$$

Thus, even if an unauthorized entity could access the Bloom filter and determine whose calls are intentionally not being offloaded, there would still be only a 12.9% chance that such person actually was subject to LI.

If a full overlap is considered among the different groups, the conditional probability that a subscriber marked for denying offload by the Bloom filter actually is a target of LI is still only:

$$\begin{matrix}P ( Surveillance Target \text{\textbar} Offload disabled ) = \frac{P ( Surveillance Target )}{P ( Offload Disabled )} \\ = \frac{4 \%}{25.5 \%} \\ = 15.7 \%\end{matrix}$$

In either case, most of the subscribers whose offload is disabled are not the targets of surveillance.

Let us compare the above with the case where the user IDs are directly passed from the core network to a local node without the use of Bloom filters. Let us further compare those scenarios with several other permutations, including the use of a Bloom filter with different variations of including surveillance targets, random targets, and users whose policies preclude them from being offloaded as described earlier in this paper. The same example described above is used. That is, there are 50 subscribers, 2 under surveillance and 5 whose relevant policy prohibits local offload and, when a Bloom filter is used, one hash function is employed and the Bloom filter has 64 elements. When the random process is included, 2 random users are selected.

Let us consider the following six different exemplary permutations:
Case 1—IDs passed directly from core network to local node—No overlap
Case 2—Case 1 with max overlap
Case 3—IDs passed from core network to local node using Bloom filter—No overlap
Case 4—Case 3 with max overlap
Case 5—IDs passed from core network to local node using Bloom filter and including random users—No overlap
Case 6—Case 5 with max overlap

The conditional probabilities of being the target of surveillance when offload is disabled results are shown in Table 3.

TABLE 3
Conditional Probability of being the target of surveillance when offload is disabled

| | | | | P(False | P(Offload | P(Surveillance\| |
|---|---|---|---|---|---|---|
| Case | P(Surveillance) | P(Policy) | P(Random) | Alarm) | Disabled) | Offload Disabled) |
| 1 | 0.04 | 0.10 | 0.00 | 0.00 | 0.14 | 0.29 |
| 2 | 0.04 | 0.10 | 0.00 | 0.00 | 0.10 | 0.40 |
| 3 | 0.04 | 0.10 | 0.00 | 0.10 | 0.24 | 0.17 |
| 4 | 0.04 | 0.10 | 0.00 | 0.07 | 0.17 | 0.24 |
| 5 | 0.04 | 0.10 | 0.04 | 0.14 | 0.32 | 0.13 |
| 6 | 0.04 | 0.10 | 0.04 | 0.07 | 0.17 | 0.24 |

For the cases (1 and 2) where there is no Random Process or false alarms as a result of the Bloom filter (since there is no Bloom filter), the conditional probability of a user being under surveillance given that offload is disabled is between 0.29 and 0.40. For the cases (3 and 4) where there is a Bloom filter used without the Random Process, the conditional probability drops to between 0.17 and 0.24. Finally, for the cases (5 and 6) where both false alarms occur (as a result of the use of a Bloom filter) and the Random Process is used, the conditional probability drops even more, to between 0.13 and 0.24. It is possible to fine tune the conditional probability result using the Random Process and the characteristics of the false positives with a Bloom filter. The conclusion of the above is that using just a Bloom filter or using both a Bloom filter and the Random Process enhances the obfuscation of which users are really the targets of surveillance, as evidenced by the conditional probability shown in Table 3.

### 5 CONCLUSION

Throughout the disclosure, one of skill will understand that certain representative embodiments may be used in the alternative or in combination with other representative embodiments.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WRTU, UE, terminal, base station, RNC, or any host computer.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits.

The data bits may also be maintained on a computer readable medium including magnetic disks, optical disks, and any other volatile (e.g., Random Access Memory (“RAM”)) or non-volatile (“e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

No element, act, or instruction used in the description of the present application should be construed as critical or essential to the invention unless explicitly described as such. In addition, as used herein, the article “a” is intended to include one or more items. Where only one item is intended, the term “one” or similar language is used. Further, the terms “any of” followed by a listing of a plurality of items and/or a plurality of categories of items, as used herein, are intended to include “any of,” “any combination of,” “any multiple of,” and/or “any combination of” multiples of the items and/or the categories of items, individually or in conjunction with other items and/or other categories of items. Further, as used herein, the term “set” is intended to include any number of items, including zero. Further, as used herein, the term “number” is intended to include any number, including zero.

Moreover, the claims should not be read as limited to the described order or elements unless stated to that effect. In addition, use of the term “means” in any claim is intended to invoke 35 U.S.C. §112, ¶6, and any claim without the word “means” is not so intended.

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

A processor in association with software may be used to implement a radio frequency transceiver for use in a wireless transmit receive unit (WRTU), user equipment (UE), terminal, base station, Mobility Management Entity (MME) or Evolved Packet Core (EPC), or any host computer. The WRTU may be used m conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the invention has been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

### 6 REFERENCES

[1] U.S. Published Patent Application No. 2013/0326631
[2] M. Ripeanu and A. Iamnitchi, “Bloom Filters—Short Tutorial,” www.cs.uchicago.edu/˜matei/PAPERS/bf.doc.
[3] B. Bloom, “Space/time trade-offs in hash coding with allowable errors,” Communications of the ACM, 13(7):422-426, 1970.
[4] “The Bloom Filter—Probably Answering the Question ‘Do I Exist?’,” http://nullwords.wordpress.com/2013/04/03/the-bloom-filter-probably-answering-the-question-do-i-exist/[5]
[5] M. Mitzenmacher, “Beyond Bloom Filters: Approximate Concurrent State Machines,” www.eecs.harvard.edu/˜michaelm/TALKS/HashingTalk.ppt
[6] “Bloom Filters—The Math,” http://pages.cs.wisc.edu/˜cao/papers/summary-cache/node8.html
[7] 3GPP TS 33.320, “Security of Home Node B (HNB)/Home evolved Node B (HeNB) (Release 12)”
[8] “FNV Hash,” http://www.isthe.com/chongo/tech/comp/fnv/[9]
[9] “MurMurHash3, an ultra-fast hash algorithm for C#/.NET,” http://blog.teamleadnet.com/2012/08/murmurhash3-ultra-fast-hash-algorithm.html
[10] http://www.techhive.com/article/2044580/is-atandt-sprint-or-verizon-the-largest-u-s-mobile-phone-carrier-it-may-not-matter.html
[11] K. Christensen, A. Roginsky, M. Jimeno, “A new analysis of the false positive rate of a Bloom filter,” http://www.csee.usf.edu/˜christen/energy/ipl10.pdf
[12] M. Mitzenmacher, “Compressed Bloom Filters,” http://www.eecs.harvard.edu/˜michaelm/NEWWORK/postscripts/cbf2.pdf
[13] 3GPP TS 33.108, “Handover interface for Lawful Interception (LI) (Release 12)”
[14] 3GPP TS 24.312, “Access Network Discovery and Selection Function (ANDSF) Management Object (MO) (Release 12)”
[15] “Chapter 4 Conditional Probability,” http://www.dartmouth.edu/˜chance/teaching_aids/books_articles/probability_book/Chapter4.pdf
[16] “Secure and Trusted Femtocells,” http://www.mindspeed.com/assets/001/PC-107259-WP-H-Secure_and_Trusted_Femtocells_v1_{—}2.pdf

1. A method of storing at a network node the identities of users of a telecommunications network that are in a first group of users, the method comprising:
storing a Bloom filter populated with the hashed identities of users in the first group of users.

2. The method of claim 1 further comprising:
testing a first user identity corresponding to a first User Equipment (UE) attached to the network node against the Bloom filter to determine if the first user identity is in the first group of users.

3. The method of claim 2 wherein the testing comprises hashing the first user identity UE using at least one hashing function to generate at least one hash value and determining if a location in the Bloom filter corresponding to the at least one hash value is set.

4. The method of claim 3 further comprising:
if the testing indicates that the first user identity hashed to a location in the Bloom filter that is set, processing data flows involving the first user in a first manner; and
if the testing indicates that the first user identity hashed to a location in the Bloom filter that is not set, processing data flows involving the first user in a second manner.

5. The method of claim 4 wherein the first manner of processing comprises performing Lawful Intercept of data flows involving the first user.

6. The method of claim 4 wherein the second manner comprises not performing LI of data flows involving the first user.

7. The method of claim 1 wherein the first group of users comprises users subject to LI.

8. The method of claim 4 wherein the first manner of processing comprises transmitting a copy of data flow information pertaining to communication sessions involving the first UE to the core network; and
the second manner of processing comprises not transmitting a copy of data flow information pertaining to communication sessions involving the first UE to the core network.

9. The method of claim 4 wherein the first manner of processing comprises permitting communication sessions involving the first UE to be offloaded so that data flows of the communication session would not necessarily pass through the core network; and
the second manner of processing comprises not permitting communication sessions involving the first UE to be offloaded so that data flows of the communication session would not necessarily pass through the core network.

10. The method of claim 1 wherein the Bloom filter is a counting Bloom filter and wherein a location in the Bloom filter is set if the value at that location is non-zero.

11. A method for conveying user identities of surveillance targets for Lawful Intercept to a network node, the method comprising:
creating a Bloom filter populated with the hashed user identities corresponding to surveillance targets; and
transmitting to the network node data at least partially defining the Bloom filter, said data at least partially defining the Bloom filter including data defining the hash values of user corresponding to surveillance targets.

12. The method of claim 11 wherein the transmitting comprises transmitting data for populating the Bloom filter with the user identities of the surveillance targets, wherein the data for populating the Bloom filter comprises hash values of user identities corresponding to surveillance targets.

13. The method of claim 11 wherein the transmitting comprises transmitting a null Bloom filter to the network node and subsequently transmitting information describing updates to the Bloom filter, wherein the information describing updates comprises hash values corresponding to user identities of users whose surveillance status has changed.

14. The method of claim 13 wherein creating the Bloom filter comprises defining a size of the Bloom Filter, a type of the Bloom filter, and at least one hashing function to be used to populate the Bloom filter.

15. The method of claim 14 wherein creating the Bloom filter further comprises hashing the user identity of at least one surveillance target using the hash function to generate a hash value and populating the Bloom filter with the hash value.

16. The method of claim 15 wherein the hashing comprises hashing the user identity using multiple hash functions to generate multiple hash values for each user identity.

17. The method of claim 15 wherein creating the Bloom filter further comprises populating the Bloom filter with user identities of users that are not surveillance targets.

18. The method of claim 17 wherein populating the Bloom filter with user identities of users that are not surveillance targets comprises adding random user identities to the Bloom filter.

19. The method of claim 11 wherein the Bloom filter is a counting Bloom filter.

20. The method of claim 11 wherein the transmitting comprises transmitting via an X1-1 interface.

21. The method of claim 11 further comprising:
receiving data flow information from the local node associated with a particular user identity, including the particular user identity;
determining if the particular user identity corresponds to a surveillance target;
if the particular user identity corresponds to a surveillance target, deciding to forward the data flow information to a law enforcement agency; and
if the particular user identity corresponds to a user who is not a surveillance target, deciding to not forward the data flow information to a law enforcement agency.

22. A method of performing lawful intercept at a local node attached to a core communication network, the method comprising:
storing at the local node a Bloom filter populated with user identities corresponding to surveillance targets;
testing the user identity of a first User Equipment (UE) attached to the local node against the Bloom filter to determine if the user identity is a user identity indicated as corresponding to a surveillance target;
commencing a data flow through the local node involving the first UE; and
if (1) the testing indicates that the user identity of the first UE corresponds to a surveillance target and (2) the communication session is designated for offload from the core network, offloading the communication session and transmitting a copy of data flow information pertaining to communication sessions involving the first UE to the core network.

23. The method of claim 22 wherein the testing comprises hashing the user identity of the first UE using at least one hashing function to generate at least one hash value and determining if a location in the Bloom filter corresponding to the at least one hash value is set.

24. The method of claim 22 further comprising:
receiving from the core network data for populating the Bloom filter with the hashed user identities of users under surveillance; and
populating the Bloom filter in accordance with the data received from the core network.

25. The method of claim 24 wherein the data for populating the Bloom filter comprises update data defining updates to the Bloom filter, the update data comprising hash values corresponding to user identities of users whose surveillance status has changed.

26. The method of claim 24 further comprising:
receiving from the core network data defining a null Bloom filter; and
receiving from the core network data defining hash values of user identities corresponding to surveillance targets.

27. The method of claim 24 further comprising:
receiving from the core network data defining a size of the Bloom filter, the type of Bloom filter, and at least one hashing function to be used to populate the Bloom filter.

28. The method of claim 27 wherein the data defining at least one hashing function comprises data defining multiple hashing functions used to populate the Bloom filter.
